(19) United States
(12) Patent Application Publication
(10) Pub. No.: US 2015/0248373 A1
(43) Pub. Date: Sep. 3, 2015

(54) BIT ALLOCATION OVER A SHARED BUS TO FACILITATE AN ERROR DETECTION OPTIMIZATION

(71) Applicant: QUALCOMM Incorporated, San Diego, CA (US)

(72) Inventor: Shoichiro Sengoku, San Diego, CA (US)

(21) Appl. No.: 14/634,106

(22) Filed: Feb. 27, 2015

Related U.S. Application Data
(60) Provisional application No. 61/946,647, filed on Feb. 28, 2014.

(51) Int. Cl. G06F 13/42; G06F 11/22; G06F 11/16; G06F 11/30

(52) U.S. Cl. CPC G06F 13/4291; G06F 11/3027; G06F 11/221; G06F 11/1679

(57) ABSTRACT

Various aspects directed towards facilitating an error detection optimization over a shared bus are disclosed. A master device is coupled to a slave device, and an encoded communication of a word is facilitated between the master device and the slave device via a control data bus. The encoded communication is encoded according to a protocol that allocates a plurality of least significant bits of the encoded communication to facilitate maximizing an error detection constant. The protocol allocates the plurality of least significant bits to include at least one additional error detection bit or at least a first most significant bit of a data portion of the word.

### CROSS-REFERENCE TO RELATED APPLICATIONS

This application claims priority to and the benefit of U.S. Provisional Patent Application No. 61/946,647, filed on Feb. 28, 2014, the entire content of which is hereby incorporated by reference.

### BACKGROUND

1. Field

The present disclosure pertains to enabling efficient operations over a shared bus and, more particularly, allocating bits according to a desired word format to facilitate an error detection optimization over a shared bus.

2. Background

Generally, a shared bus may be used when coupling multiple devices. For instance, an Inter-Integrated Circuit (I2C, and also referred to as I²C) is a multi-master serial single-ended bus used for attaching low-speed peripherals to a motherboard, embedded system, cellphone, or other electronic devices. The I2C bus includes a Serial Clock Line (SCL) and a Serial Data Line (SDA) with 7-bit addressing. The I2C bus has two roles for nodes: master and slave. A master node is a node that generates the clock and initiates communication with slave nodes. A slave node is a node that receives the clock and responds when addressed by the master. The I2C bus is a multi-master bus which means any number of master nodes can be present. Additionally, master and slave roles may be changed between messages (after a STOP is sent). I2C defines basic types of messages, each of which begins with a START and ends with a STOP.

In the context of a camera implementation, unidirectional transmissions may be used to capture an image from an image sensor and transmit corresponding image data to memory in a baseband processor, while control data may be exchanged between the baseband processor and the image sensor as well as other peripheral devices. In one example, a Camera Control Interface (CCI) protocol may be used for such control data between the baseband processor and the image sensor (and/or one or more slave nodes). In another example, the CCI protocol may be implemented over an I2C serial bus between the image sensor and the baseband processor.

Error detection algorithms are often implemented to improve the accuracy of shared bus communications. Such errors, however, are often not detected by conventional error detection algorithms. Accordingly, implementing an algorithm in which errors communicated on a shared bus are more accurately detected is desirable.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide methods, apparatuses, computer program products, and processing systems directed towards facilitating an error detection optimization over a shared bus. In one aspect, the disclosure provides a method, which includes coupling a master device to a slave device, and facilitating an encoded communication of a word between the master device and the slave device via a control data bus. For this particular implementation, the encoded communication is encoded according to a protocol that allocates a plurality of least significant bits of the encoded communication to facilitate maximizing an error detection constant. Here, such maximization is achieved via a protocol that allocates the plurality of least significant bits to include at least one additional error detection bit or at least a first most significant bit of a data portion of the word.

In another aspect, a device configured to facilitate an error detection optimization over a shared bus is disclosed. The device comprises a processor coupled to a control data bus. Here, the processor is configured to facilitate an encoded communication of a word between a master device and a slave device via the control data bus. The encoded communication in this implementation is encoded according to a protocol that allocates a plurality of least significant bits of the encoded communication to facilitate maximizing an error detection constant. In particular, the protocol allocates the plurality of least significant bits to include at least one additional error detection bit or at least a first most significant bit of a data portion of the word.

In a further aspect, another device configured to facilitate an error detection optimization over a shared bus is disclosed. For this implementation, the device comprises means for coupling a master device to a slave device, and means for facilitating an encoded communication of a word between the master device and the slave device via a control data bus. Here, the encoded communication is encoded according to a protocol that allocates a plurality of least significant bits of the encoded communication to facilitate maximizing an error detection constant. Namely, the protocol allocates the plurality of least significant bits to include at least one additional error detection bit or at least a first most significant bit of a data portion of the word.

In yet another aspect, a non-transitory machine-readable storage medium configured to facilitate an error detection optimization over a shared bus via one or more instructions stored thereon is disclosed. Here, when executed by at least one processor, the one or more instructions cause the at least one processor to couple a master device to a slave device, and facilitate an encoded communication of a word between the master device and the slave device via a control data bus. In this implementation, the encoded communication is encoded according to a protocol that allocates a plurality of least significant bits of the encoded communication to facilitate maximizing an error detection constant. In particular, the protocol allocates the plurality of least significant bits to include at least one additional error detection bit or at least a first most significant bit of a data portion of the word.

These and other disclosed aspects will become more fully understood upon a review of the detailed description, which follows. Other aspects, features, and aspects of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### DRAWINGS

Various features, nature, and advantages may become apparent from the detailed description set forth below when taken in conjunction with the drawings in which like reference characters identify correspondingly throughout.

FIG. 1 illustrates an exemplary multi-master bus in accordance with an aspect of the disclosure.

FIG. 2 is a block diagram of an exemplary master/slave device according to an aspect of the disclosure.

FIG. 3 is a block diagram illustrating a device having a baseband processor and an image sensor and implementing an image data bus and a multi-mode control data bus.

FIG. 4 illustrates how a clock may be embedded within symbol to symbol transitions in CCIe mode, thereby allowing the use of the two lines (i.e., SDA line and SCL line) in an I2C bus for data transmissions.

FIG. 5 is a block diagram illustrating an exemplary method for transcoding of data bits into transcoded symbols at a transmitter to embed a clock signal within the transcoded symbols.

FIG. 6 illustrates an exemplary conversion between transition numbers and sequential symbols.

FIG. 7 illustrates the conversion between transition numbers and sequential symbols.

FIG. 8 illustrates a method for converting binary bits into ternary numbers from most significant bit to least significant bit.

FIG. 9 illustrates a transmitter-side logic circuit for converting binary bits into ternary numbers from most significant bit to least significant bit.

FIG. 10 illustrates a method for converting ternary numbers into binary bits from most significant bit to least significant bit.

FIG. 11 illustrates a receiver-side logic circuit for converting a twelve digit ternary number into twenty bits.

FIG. 12 conceptually illustrates a bit 19 (i.e., the 20^{th} bit when the bit count starts at the first bit being bit 0) is mostly unused in the CCIe protocol and may be used for commands between devices on the shared bus.

FIG. 13 illustrates an exemplary general call for CCIe mode entry indicator that may be sent by a master device over a shared bus to indicate to slave devices that the shared bus is switching to operate from I2C mode to CCIe mode.

FIG. 14 illustrates an exemplary CCIe call that may be issued by a CCIe master device (e.g., master device in FIG. 1 while in I2C mode) to indicate a transition from CCIe mode to I2C mode to all CCIe able devices.

FIG. 15 illustrates an exemplary CCIe slave identifier (SID) word format.

FIG. 16 illustrates an exemplary CCIe address word format.

FIG. 17 illustrates an exemplary write data word format.

FIG. 18 illustrates an exemplary read specification word format.

FIG. 19 illustrates an exemplary read data word format.

FIG. 20 illustrates an exemplary timing diagram of an I2C one byte write data operation.

FIG. 21 illustrates an exemplary CCIe transmission in which data bits have be transcoded into twelve symbols for transmission over the SDA line and the SCL line.

FIG. 22 illustrates an exemplary mapping of the 20^{th} bit (bit 19) resulting from the encoding scheme disclosed herein.

FIG. 23 illustrates details of a sub-region within the exemplary mapping of the 20^{th} bit (bit 19) region of FIG. 22.

FIG. 24 illustrates various symbol error conditions that may occur.

FIG. 25 illustrates a table showing the possible errors in the transmitted symbol sequence 0321_{—}0321_{—}0321 (which translates to binary sequence 0000_{—}0000_{—}0000_{—}0000_{—}0000 and ternary number 0000_{—}0000_{—}0000₃) and how such errors are detectable within the three least significant bits.

FIG. 26 illustrates a table showing the possible errors in the transmitted symbol sequence 2301_{—}2301_{—}2301 (which translates to binary sequence 0100_{—}0000_{—}1101_{—}1111_{—}1000 and ternary number 1111_{—}1111_{—}1111₃) and how such errors are detectable within the three least significant bits.

FIG. 27 illustrates a table showing the possible errors in the transmitted symbol sequence 3131_{—}3131_{—}3131 (which translates to binary sequence 1000_{—}0001_{—}1011_{—}1111_{—}0000 and ternary number 2222_{—}2222_{—}2222₃) and how such errors are detectable within the three least significant bits.

FIG. 28 illustrates a table showing the possible errors in the transmitted symbol sequence 0132_{—}3101_{—}3231 and how such errors are detectable within the three least significant bits.

FIG. 29 illustrates a table showing the possible errors in the transmitted symbol sequence 2030_{—}2120_{—}3021 and how such errors are detectable within the three least significant bits.

FIG. 30 illustrates a table showing the possible errors in the transmitted symbol sequence 3231_{—}0132_{—}3101 and how such errors are detectable within the three least significant bits.

FIG. 31 is a block diagram illustrating exemplary components of a master/slave device in accordance with the disclosure.

FIG. 32 is a flow chart illustrating an exemplary encoding/decoding methodology in accordance with an aspect of the disclosure.

FIG. 33 is a block diagram illustrating exemplary encoder components according to an aspect of the disclosure.

FIG. 34 is a flow chart illustrating an exemplary encoding methodology in accordance with an aspect of the disclosure.

FIG. 35 is a block diagram illustrating exemplary decoder components according to an aspect of the disclosure.

FIG. 36 is a flow chart illustrating an exemplary decoding methodology in accordance with an aspect of the disclosure.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures, and techniques may not be shown in detail in order not to obscure the embodiments.

### Overview

As discussed in the background, because of the limitations of conventional error detection algorithms, errors communicated on a shared bus are often missed. The aspects disclosed herein are directed towards overcoming such limitations by allocating bits according to a desired word format to facilitate an error detection optimization. Namely, aspects directed towards utilizing a flexible word format for shared bus communications are disclosed in which additional error detection bits may be strategically allocated to facilitate an error detection optimization.

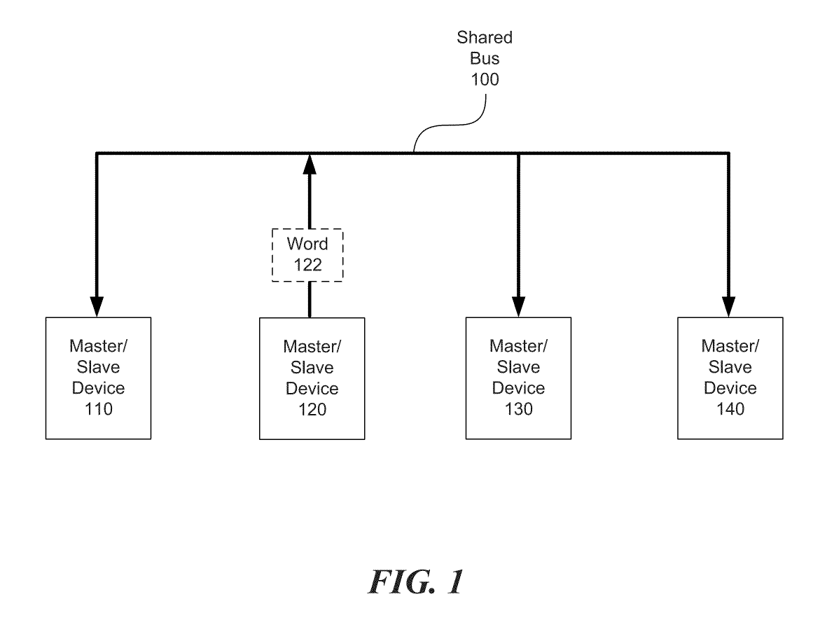

Referring next to FIG. 1, an exemplary multi-master bus architecture that facilitates the error detection optimization aspects disclosed herein is provided. As illustrated, a plurality of master/slave devices 110, 120, 130, and 140 are coupled to each other via a shared bus 100. Here, it is contemplated that the shared bus 100 is a multi-master bus, wherein any of the master/slave devices 110, 120, 130, and 140 may operate as a master device or a slave device. In this particular example, the master/slave device 120 transmits a word 122 to the other master/slave devices 110, 130, and 140 via the shared bus 100, wherein the word 122 is encoded by the master/slave device 120 according to a bit allocation scheme that optimizes error detection. For instance, such a scheme may optimize error detection by allocating a greater number of error detection bits relative the number of error detection bits allocated in a non-optimized scheme. To properly decode the word 122, it is thus contemplated that the master/slave devices 110, 130, and 140 detect whether the word 122 was encoded with an error detection optimization, wherein the word 122 is then decoded based on a corresponding bit allocation scheme.

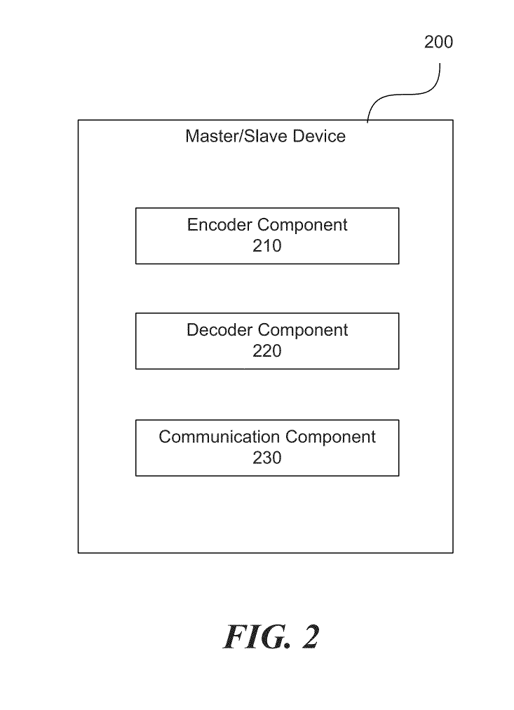

In FIG. 2, a block diagram of an exemplary master/slave device is provided according to an aspect of the disclosure. As illustrated, the master/slave device 200 comprises various components to facilitate performing the error detection optimizations disclosed herein, including an encoder component 210, a decoder component 220, and a communication component 230. It is contemplated that the master/slave device 200 may be configured as any master/slave device described herein including, for example, any of the master/slave devices 110, 120, 130, and 140 illustrated in FIG. 1. For instance, it is contemplated that the communication component 230 may be configured to transmit and receive words communicated via a shared bus, wherein the encoder component 210 is configured to optimize error detection by encoding words to include additional error detection bits, and wherein the decoder component 220 is configured to decode words that include these additional error detection bits

In a particular aspect of the disclosure, the master/slave device 200 is configured to encode/decode words according to a CCI protocol. To this end, it is noted that an extension to CCI called CCIe (Camera Control Interface extended) has been developed that converts a binary number into a ternary number which is then transcoded to symbols embedded with a clock for transmission over the I2C bus to enable higher speeds than before. In an exemplary implementation, 20-bit binary numbers are input in parallel to a ternary number converter (i.e., a Bits-to-12xT converter). After receiving all the binary bits, the ternary number converter outputs a corresponding ternary number. The output number is then sent to a transcoder in a similar manner. In an aspect of CCIe disclosed herein, a ternary transition number to sequential symbol conversion is performed on a symbol by symbol basis, which desirably requires less hardware resources than simultaneously processing multiple symbols. The symbols are then transmitted over the bus.

The use of ternary number space and conversion to symbols results in an extra bit becoming available. In one example, this extra bit may be the most significant so a region of ternary numbers become available to support other functionality not otherwise available. For instance, error detection, hot-plug function, and/or SID scanning may all be facilitated due to the extra information that may be included in this extra bit.

### Exemplary Operating Environment

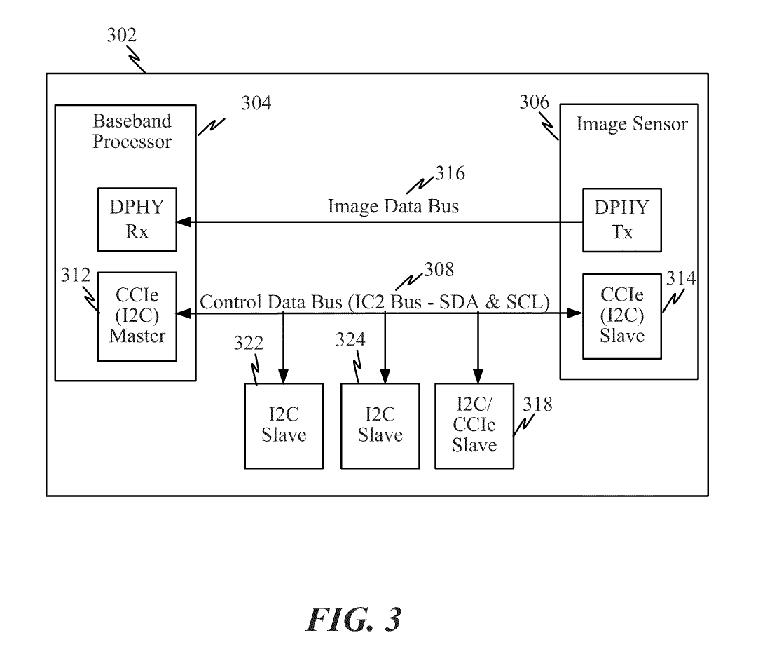

FIG. 3 is a block diagram illustrating a device 302 having a baseband processor 304 and an image sensor 306 and implementing an image data bus 316 and a multi-mode control data bus 308. While FIG. 3 illustrates the multi-mode control data bus 308 within a camera device, it should be clear that this control data bus 308 may be implemented in various different devices and/or systems. Image data may be sent from the image sensor 306 to the baseband processor 304 over an image data bus 316 (e.g., a high speed differential DPHY link).

In one example, the control data bus 308 may be an I2C bus comprising two wires, a clock line (SCL) and a serial data line (SDA). The clock line SCL may be used to send a clock used to synchronize all data transfers over the I2C bus (control data bus 308). The data line SDA and clock line SCL are coupled to all devices 312, 314, and 318 on the I2C bus (control data bus 308). In this example, control data may be exchanged between the baseband processor 304 and the image sensor 306 as well as other peripheral devices 318, 322, and/or 324 via the control data bus 308. The standard clock (SCL) speed for I2C is up to 100 KHz. The standard clock SCL speed in I2C fast mode is up to 400 KHz, and in I2C fast mode plus (Fm+) it is up to 1 MHz. These operating modes over an I2C bus may be referred to as a camera control interface (CCI) mode when used for camera applications.

According to one aspect, an improved mode of operation (i.e., with control data bus transmission frequencies greater than 1 MHz) may be implemented over the multi-mode control data bus 308 to support camera operation. This improved mode of operation over an I2C bus may be referred to as a camera control interface extension (CCIe) mode when used for camera applications. In CCIe mode, the SCL line and the SDA line may both be used to transmit data while a clock is embedded symbol to symbol transitions over the two lines. In this example, the baseband processor 304 includes a master node 312 and the image sensor 306 includes a slave node 314, both the master node 312 and slave node 314 may operate according to the camera control interface extension (CCIe) mode over the control data bus 308 without affecting the proper operation of other legacy I2C devices coupled to the control data bus 308. According to one aspect, this improved mode over the control data bus 308 may be implemented without any bridge device between CCIe devices and legacy I2C slave devices.

A protocol is provided that permits I2C-compatible devices and CCIe-compatible devices to be concurrently coupled to the shared control data bus 308. The control data bus 308 may dynamically switch between operating according to distinct communication protocols (e.g., I2C mode and CCIe mode). As previously noted, communications and/or access to the shared control data bus 308 is managed by the multi-mode master device 312. The master device transmits an entry call to indicate that the control data bus 308 is to switch its communication protocol from a first protocol mode (e.g., I2C mode) to a second protocol mode (e.g., CCIe mode). Similarly, the master device transmits an exit call to indicate that the control data bus 308 is to switch its communication protocol from the second protocol mode (e.g., CCIe mode) to the first protocol mode (e.g., I2C mode). The slave devices coupled to the shared bus 308 monitor for these entry and exit calls to ascertain when they may operate on the shared bus 308.

### Exemplary CCIe Encoding Technique

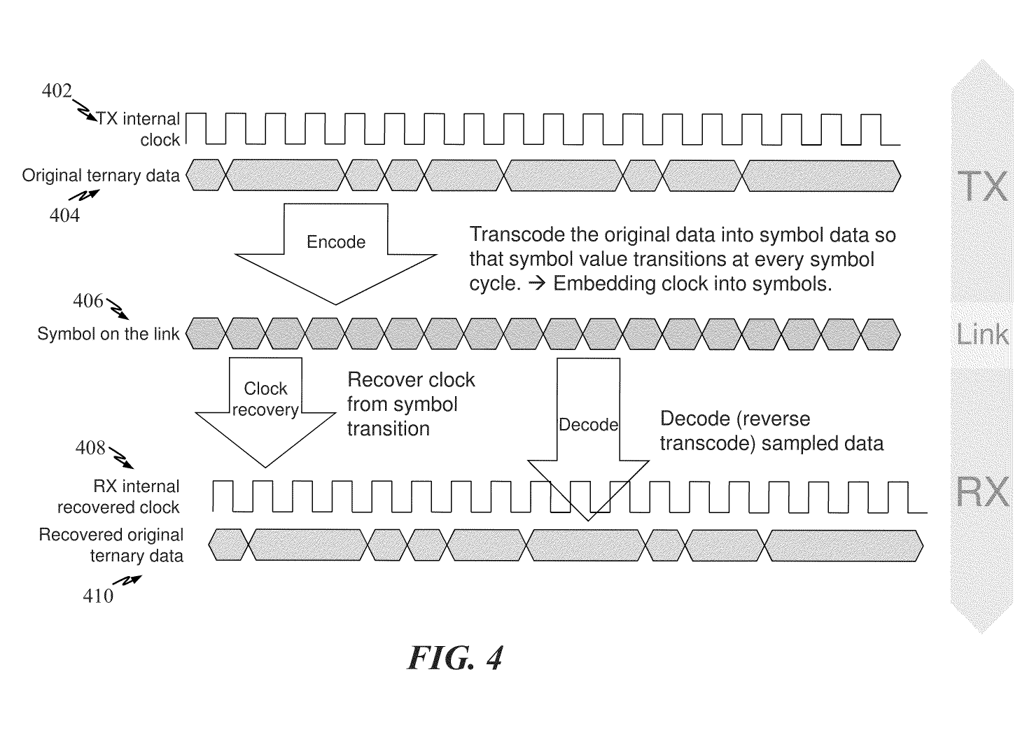

FIG. 4 illustrates how a clock may be embedded within symbol to symbol transitions in CCIe mode, thereby allowing the use of the two lines (i.e., SDA line and SCL line) in an I2C bus for data transmissions. In one example, this embedding of the clock may be achieved by transition clock transcoding. For instance, the data 404 to be transmitted over the physical link (wires) is transcoded so that transmitted symbols are guaranteed to change state at every symbol cycle or transition of the transmitted symbols 406. In one example, sequences of bits are converted into a ternary number, and each digit of the ternary number is converted into a symbol for transmission. Sequential symbols are guaranteed to be different even when two sequential digits of the ternary number are the same. Consequently, the original clock 402 can be embedded in the change of symbol states at every symbol cycle. A receiver recovers clock information 408 from the state transition at each symbol (in the transmitted symbols 406) and then reverses the transcoding of the transmitted symbols 406 to obtain the original data 410. In one example, each symbol is converted into a digit, a plurality of digits making up a ternary number, where the ternary number is then converted into a plurality of bits. Consequently, the original clock 402 can be embedded in the change of symbol states at every symbol cycle. This allows both wires of the I2C bus (e.g., control data bus 308 in FIG. 3, SDA line and SCL line) to be used to send data information. Additionally, the symbol rate can be doubled since it is no longer necessary to have a setup and hold time between clock and data signals.

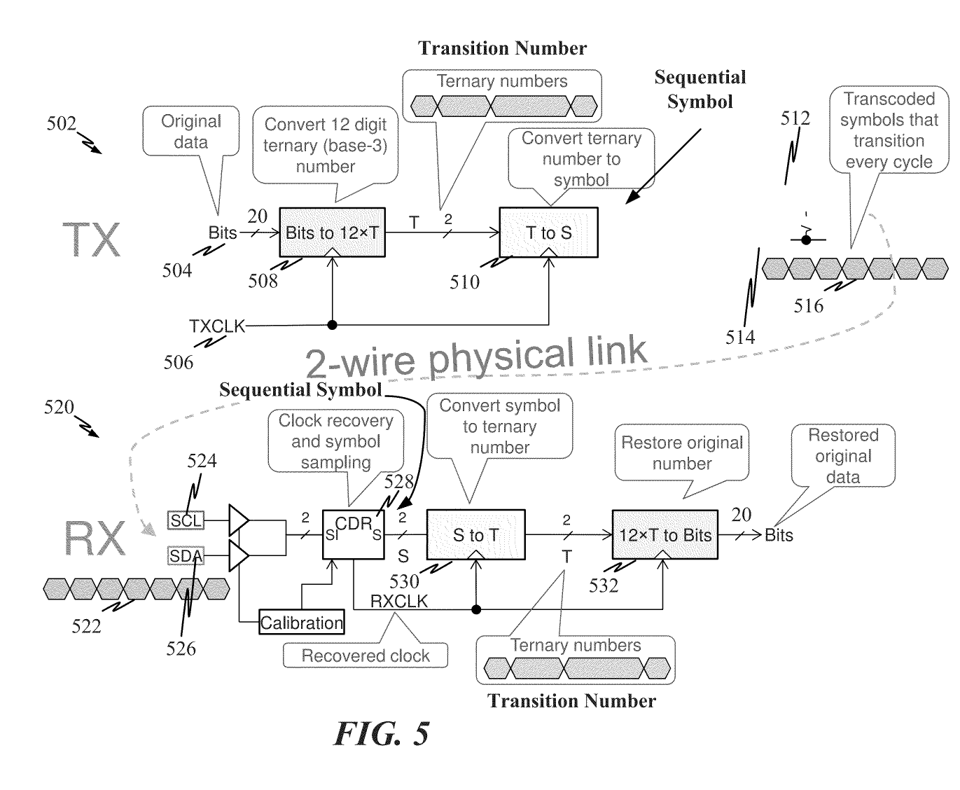

FIG. 5 is a block diagram illustrating an exemplary method for transcoding of data bits into transcoded symbols at a transmitter to embed a clock signal within the transcoded symbols. At the transmitter 502, a sequence of data bits 504 are converted into a ternary (base 3) number (i.e., a “transition number”), and the ternary numbers are then converted into (sequential) symbols which are transmitted over the clock line SCL 512 and the data line SDA 514.

In one example, an original 20 bits of binary data is input into a bit-to-transition number converter block 508 to be converted to a 12-digit ternary number. Each digit of a 12-digit ternary number represents a “transition number”. Two consecutive transition numbers may have be the same numbers (i.e., consecutive digits of the ternary number may be the same). Each transition number is converted into a sequential symbol at a transition-to-symbol block 510 such that no two consecutive sequential symbols have the same values. Because a transition is guaranteed at every sequential symbol, such sequential symbol transition may serve to embed a clock signal. Each sequential symbol 516 is then sent over a two wire physical link (e.g., I2C bus comprising a SCL line 512 and a SDA line 514).

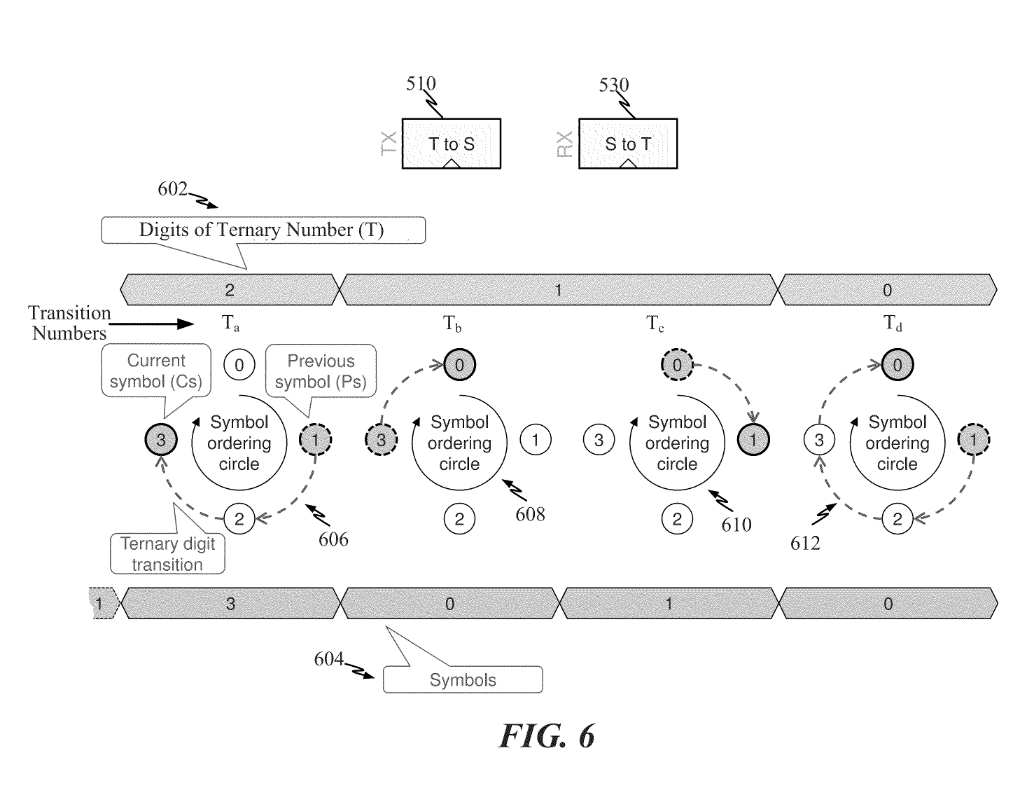

FIG. 6 illustrates an exemplary conversion between transition numbers 602 and sequential symbols 604. An individual digit of ternary number, base-3 number, also referred to as a transition number, can have one of the three (3) possible digits or states, 0, 1, or 2. While the same digit may appear in two consecutive digits of the ternary number, no two consecutive sequential symbols have the same value. The conversion between a transition number and a sequential symbol guarantees that the sequential symbol always changes (from sequential symbol to sequential symbol) even if consecutive transition numbers are the same.

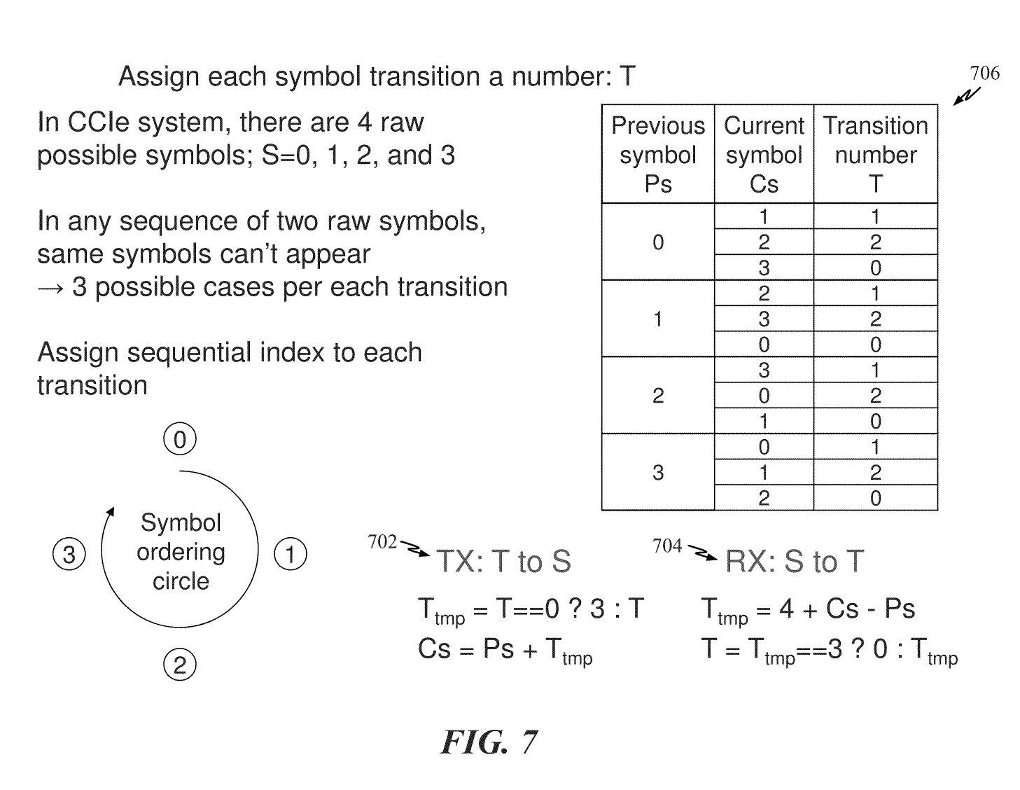

The conversion function is set forth illustratively in FIG. 7. On the transmitter side (TX: T to S) 702, a transition number (T) may be converted to a sequential symbol (S). For instance, a current sequential symbol (Cs) may be obtained based on a previous sequential symbol (Ps) and a temporary transition number (Tₜₘₚ) that is a function of a current transition number (T). The temporary transition number (Tₜₘₚ) may be obtained by comparing the current transition number T to zero and when T=zero, the temporary transition number (Tₜₘₚ) becomes equal to 3, else (when T not equal zero) Tₜₘₚ becomes equal to T (i.e., Tₜₘₚ=T=0 ? 3: T). The current sequential symbol may be obtained as a sum of the current sequential symbol (Cₛ) plus the previous sequential symbol (Pₛ) plus the temporary transition number (Tₜₘₚ) (i.e., Cₛ=Pₛ+Tₜₘₚ).

On the receiver side (RX: S to T) 704 the conversion operation is reversed to obtain a transition number from a current sequential symbol (Cs) and a previous sequential symbol (Ps). A temporary transition number (Tₜₘₚ) may be obtained as the sum of the current sequential symbol (Cs) plus 4 minus the previous symbol (Ps) (i.e., Tₜₘₚ=Cₛ+4−Pₛ). The current transition number (T) is equal to the temporary transition number (Tₜₘₚ), but the temporary transition number (Tₜₘₚ) is compared to three (3) and when Tₜₘₚ=3, the temporary transition number (Tₜₘₚ) becomes equal to zero (0), else (when Tₜₘₚ not equal 3) T becomes equal to Tₜₘₚ (i.e., T=Tₜₘₚ=3 ? 0: T).

A table 706 illustrates the conversion between transition numbers and sequential symbols.

Referring again to FIG. 6, an example of the conversion between transition numbers and sequential symbols is illustrated therein. For example, in a first cycle 606, the current transition number (Ta) is 2, so Tₜₘₚ is also 2, and with the previous sequential symbol Pₛ being 1, the new current sequential symbol Cₛ is now 3.

In a second cycle 608, the transition number (Tb) is 1. Since the transition number (Tb) is not equal to zero, the temporary transition number Tₜₘₚ is equal to the transition number (Tb) value of 1. The current sequential symbol (Cs) is obtained by adding the previous sequential symbol (Ps) value of 3 to the temporary transition number Tₜₘₚ of 1. Since the result of the addition operation equals 4, which is greater than 3, the rolled over number 0 becomes the current sequential symbol (Cs).

In a third cycle 610, the current transition number (T) is 1. Because the transition number T is 1, the temporary transition number Tₜₘₚ is also 1. The current sequential symbol (Cs) is obtained by adding the previous sequential symbol (Ps) value of 0 to the temporary transition number Tₜₘₚ of 1. Since the result of the addition operation equals 1, which is not greater than 3, the current symbol (Cs) is equal to 1.

In a fourth cycle 612, current transition number (T) is 0. Because the transition number T is 0, the temporary transition number Tₜₘₚ is 3.

The current sequential symbol (Cs) is obtained by adding the previous sequential symbol (Ps) value of 1 to the temporary transition number Tₜₘₚ of 3. Since the result of the addition operation is 4, which is greater than 3, the rolled over number 0 becomes the current sequential symbol (Cs).

Note that even if two consecutive ternary digits Tb and Tc have the same numbers, this conversion guarantees that two consecutive sequential symbols have different state values. Because of this, the guaranteed transition in the sequential symbols 604 may serve to embed a clock signal, thereby freeing the clock line SCL in an I2C bus for data transmissions.

Referring again to FIG. 5, at the receiver 520 the process is reversed to convert the transcoded symbols back to bits and, in the process, a clock signal is extracted from the symbol transition. The receiver 520 receives a sequence of sequential symbols 522 over the two wire physical link (e.g., I2C bus comprising a SCL line 524 and a SDA line 526). The received sequential symbols 522 are input into a clock-data recovery (CDR) block 528 to recover a clock timing and sample the transcoded symbols (S). A symbol-to-transition number converter block 530 then converts the transcoded (sequential) symbols to a transition number, i.e., one ternary digit number. Then, a transition number-to-bits converter 532 converts 12 transition numbers to restore 20 bits of original data from the 12 digit ternary number.

The example illustrated in FIGS. 5 and 6 for a 2-wire bus and 12 transition numbers may be generalized to an n-wire system and m transition numbers. If there are r possible symbol transition states per one T, T0 to Tm−1, m transitions can send rm different states, i.e., r=2ⁿ−1. Consequently, transitions T0 . . . Tm−1 contain data that can have (2ⁿ−1)^{m} different states.

This technique illustrated herein may be used to increase the link rate of a control data bus (e.g., control data bus 308 in FIG. 3) beyond what the I2C standard bus provides and is referred hereto as CCIe mode. In one example, a master device and/or a slave device coupled to the control data bus may implement transmitters and/or receivers that embed a clock signal within symbol transmissions (as illustrated in FIGS. 4, 5, 6, and 7) in order to achieve higher bit rates over the same control data bus than is possible using a standard I2C bus.

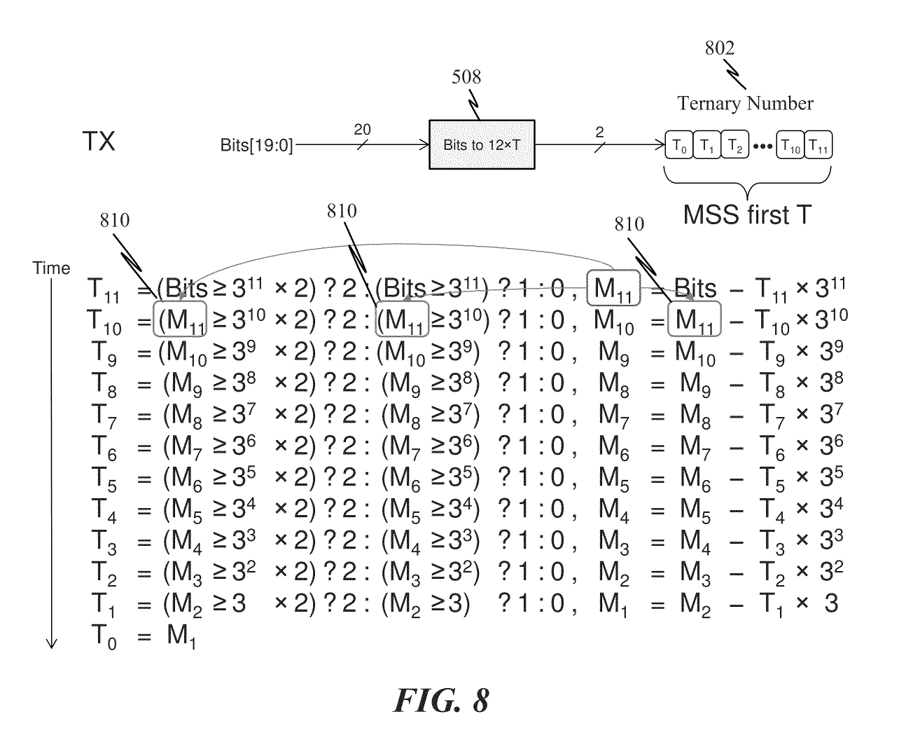

FIG. 8 illustrates a method for converting binary bits into ternary numbers from most significant bit to least significant bit. Each digit of a ternary number may be transcoded (converted) into symbols that are transmitted to a receiving device. For a 12 digit ternary number 802 with T0, T1 . . . T11 representing the ternary number, T0 represents the 3° digit (and is the least significant digit) while T11 represents the 3¹¹ digit (and is the most significant digit). Starting with the received bits (e.g., 20 bit sequence), the most significant digit T11 of the ternary number 802 is obtained first. Then, the next most significant digit T10 is obtained next. This process continues until the least significant digit T0 is obtained. Each of the digit of the ternary number 802 may also referred to as a “transition number”.

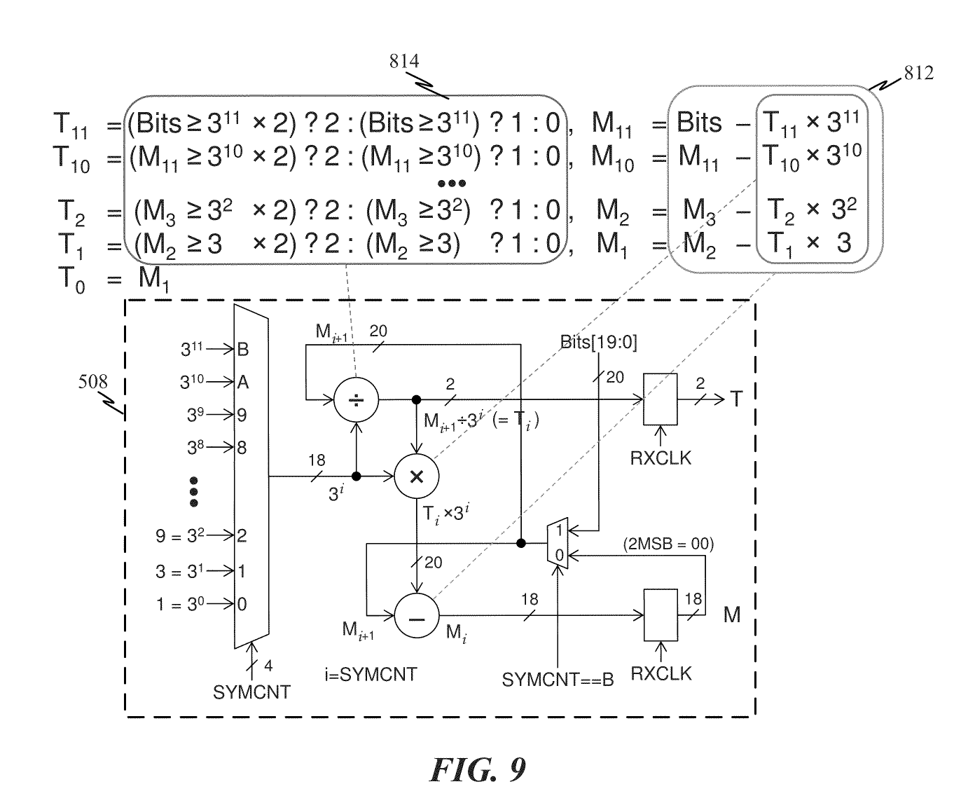

FIG. 9 illustrates a transmitter-side logic circuit for converting binary bits into ternary numbers from most significant bit to least significant bit. FIGS. 8 and 9 illustrate the 12 digit ternary number 802 being sent in order of T11, T10, T9, . . . , T0. By obtaining and sending the most significant bit first, the logic and circuitry involved is simplified in complexity. In the approach in FIGS. 8 and 9, the most significant sequential symbol is transmitted to the receiving device first, and is therefore called MSS first (most significant symbol first). As used herein “least significant symbol” refers to the transcoded symbol corresponding to the least significant digit of the ternary number 802. For example and with reference to the description of FIGS. 6 and 7, when T0 is transcoded into a sequential symbol that is the least significant symbol because it originated from the least significant ternary digit. Similarly, as used herein “most significant symbol” refers to the transcoded symbol corresponding to the most significant digit of the ternary number 802. For example and with reference to the description of FIGS. 6 and 7, when T11 is transcoded into a sequential symbol that is the most significant symbol because it originated from the most significant ternary digit. And when the symbol-to-transition number converter block 530 (FIG. 5) subsequently receives and converts the transcoded (sequential) symbol to a transition number, i.e., a digit of a ternary number it will be the most significant digit T11 first, and least significant digit T0 last.

Referring back to FIG. 5, the original data of twenty bits is converted into a ternary number in reverse order (i.e., the most significant bit is supplied to a converter first), then each digit of the ternary number (e.g., each transition number) is converted (i.e., transcoded) to a sequential symbol in reverse order, and these transcoded symbols are transmitted on the bus in reverse order (i.e., most significant symbol first).

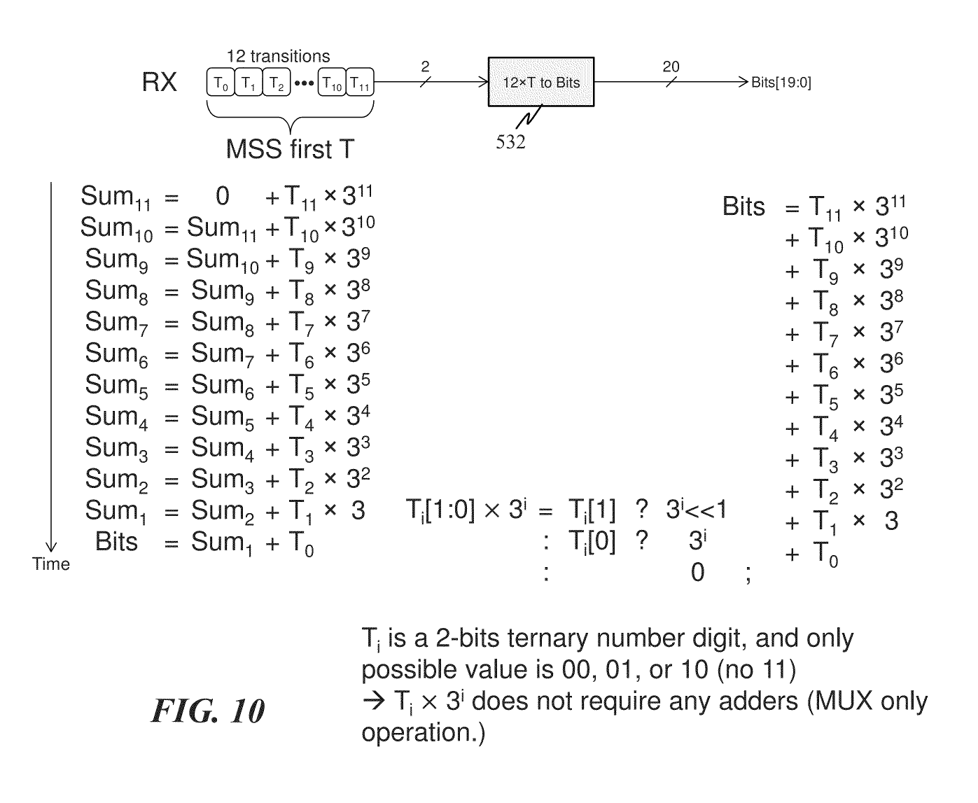

FIG. 10 illustrates a method for converting ternary numbers into binary bits from most significant bit to least significant bit. That is, this receiver-side conversion reverses the operations performed in the transmitter-side conversion illustrated in FIGS. 8 and 9. A receiving device (e.g., a slave device) receives the reverse order transmission and performs clock recovery and symbol sampling to convert the transcoded symbols back to a ternary number which is then supplied in reverse order to a receiver-side logic circuit which converts the ternary number back to the twenty bit binary original data.

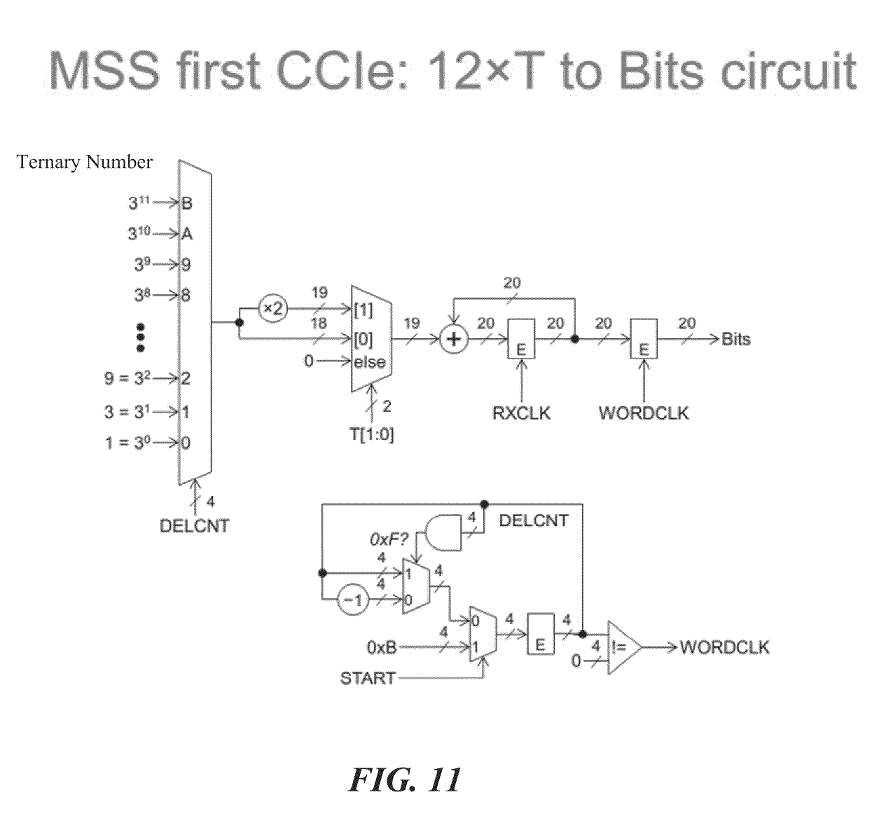

FIG. 11 illustrates a receiver-side logic circuit for converting a twelve digit ternary number into twenty bits. In other words, referring back to FIG. 5, original data of twenty bits is converted into a ternary number in reverse order (i.e., the most significant bit is supplied to a converter first), then this transition number is converted (i.e., transcoded) to sequential symbols again in reverse order, and these transcoded symbols are transmitted on the bus in reverse order. A receiving device (e.g., a slave device) receives the reverse order transmission and performs clock recovery and symbol sampling to convert the transcoded symbols back to a ternary number which is then supplied in reverse order to the circuit in FIG. 11 which converts the ternary number back to the 20 bit binary original data.

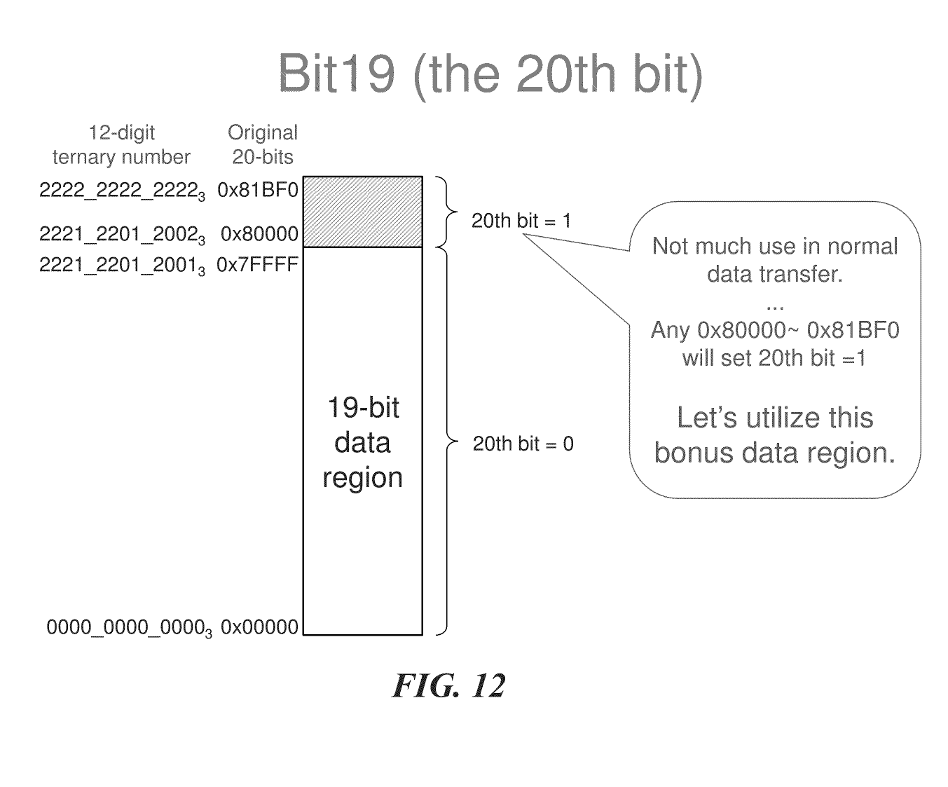

FIG. 12 conceptually illustrates how a bit 19 (i.e., the 20^{th} bit when the bit count starts at the first bit being bit 0) is mostly unused in the CCIe protocol and may be used for commands between devices on the shared bus. That is, as a result of the encoding scheme described herein, an extra bit (i.e., bit 19) is now available in the transmitted symbols. More specifically, FIG. 12 illustrates the bit 19 (i.e., the 20^{th} bit). In other words, as is typical in the computer sciences, counting bit wise begins at zero, and bit 19 is the 20^{th} bit. Here, the bits 0-18 are represented within the ternary number range of 0000_{—}0000_{—}0000₃ to 2221_{—}2201_{—}2001₃. The ternary numbers in the range of 2221_{—}2201_{—}2002₃ to 2222_{—}2222_{—}2222₃ are unused. Consequently, the ternary number range 2221_{—}2201_{—}2002₃ to 2222_{—}2222_{—}2222₃ may be used to represent bit 19 (i.e., 20^{th} bit). In other words, 2221,2201,2002₃ ternary is 10,000,000,000,000,000,000 binary (0x80000 hexadecimal) and 2222_{—}2222_{—}2222₃ ternary (0x81BF0) is the largest 12 digit ternary number possible.

### Exemplary Protocol for CCIe Mode

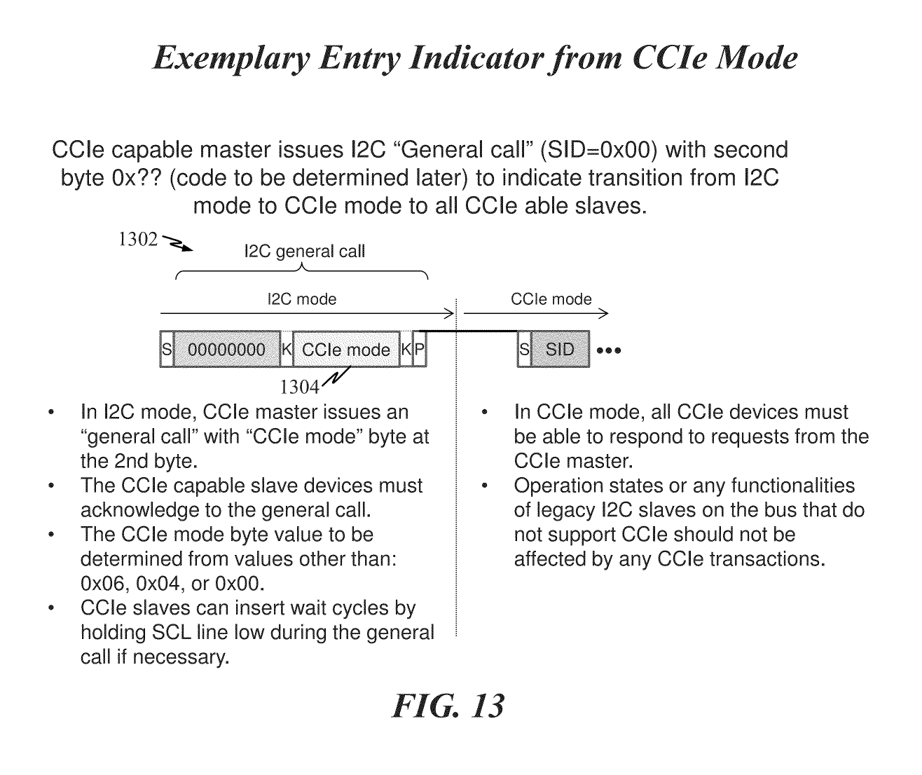

FIG. 13 illustrates an exemplary general call for CCIe mode entry indicator that may be sent by a master device over a shared bus to indicate to slave devices that the shared bus is switching to operate from I2C mode to CCIe mode. The general call 1302 may be issued by an I2C master device over the shared bus (e.g., master device 312 in FIG. 3 while in I2C mode over the SDA line and the SCL line) to indicate a transition from I2C mode to CCIe mode to all I2C-compatible devices.

In I2C mode, the CCIe master device issues this I2C general call 1302 with a “CCIe mode” byte or indicator 1304. The CCIe-compatible slave devices acknowledge receipt of the general call 1302. CCIe-compatible slave devices can insert wait cycles by holding the SCL line (e.g., of the control data bus 308 in FIG. 3) low during the general call if necessary.

Once in CCIe mode, all CCIe-compatible devices are able to respond to requests from the CCIe master device. Operational states or any functionalities of legacy I2C-compatible slave devices on the shared control data bus that do not support CCIe mode are not be affected by any CCIe transactions.

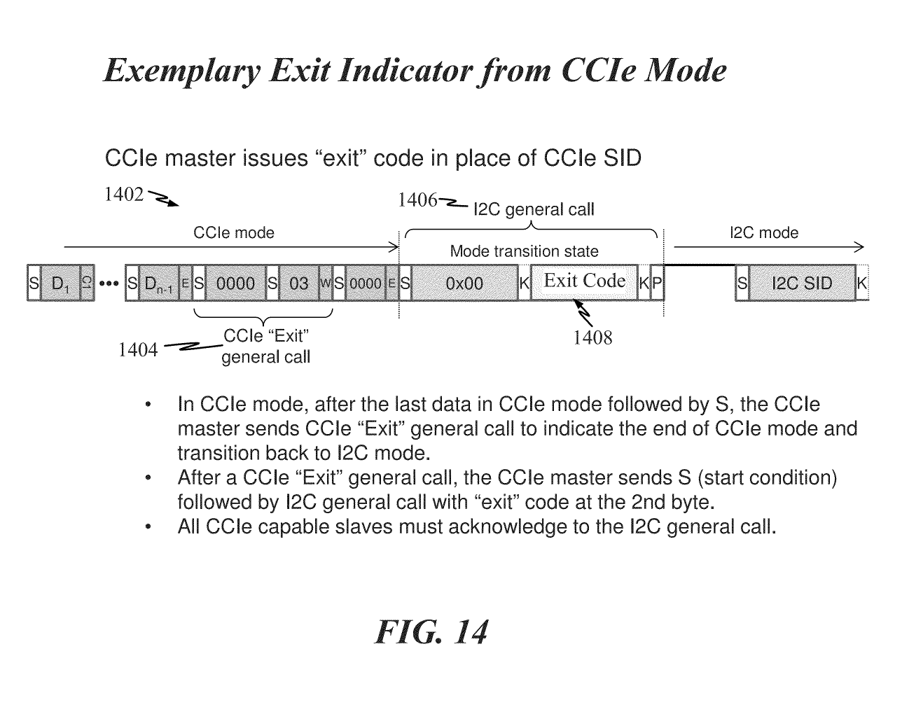

FIG. 14 illustrates an exemplary CCIe call 1402 that may be issued by a CCIe master device (e.g., master device 312 in FIG. 3 while in I2C mode) to indicate a transition from CCIe mode to I2C mode to all CCIe able devices. The CCIe master device may issue this exit call 1402 in place of CCIe SID.

In CCIe mode, after the last data in CCIe mode followed by S, the CCIe master sends special CCIe SID code, “Exit” code/indicator 1404, to indicate (e.g., to CCIe-compatible devices) the end of CCIe mode and transition back to I2C mode. Additionally, after the “exit” code/indicator 1404, the CCIe master device sends S (start-bit) followed by “general call” 1406, according to the I2C protocol, with an “exit” code 1408 at the 2nd byte within I2C protocol. All CCIe capable slaves must acknowledge to the general call 1404.

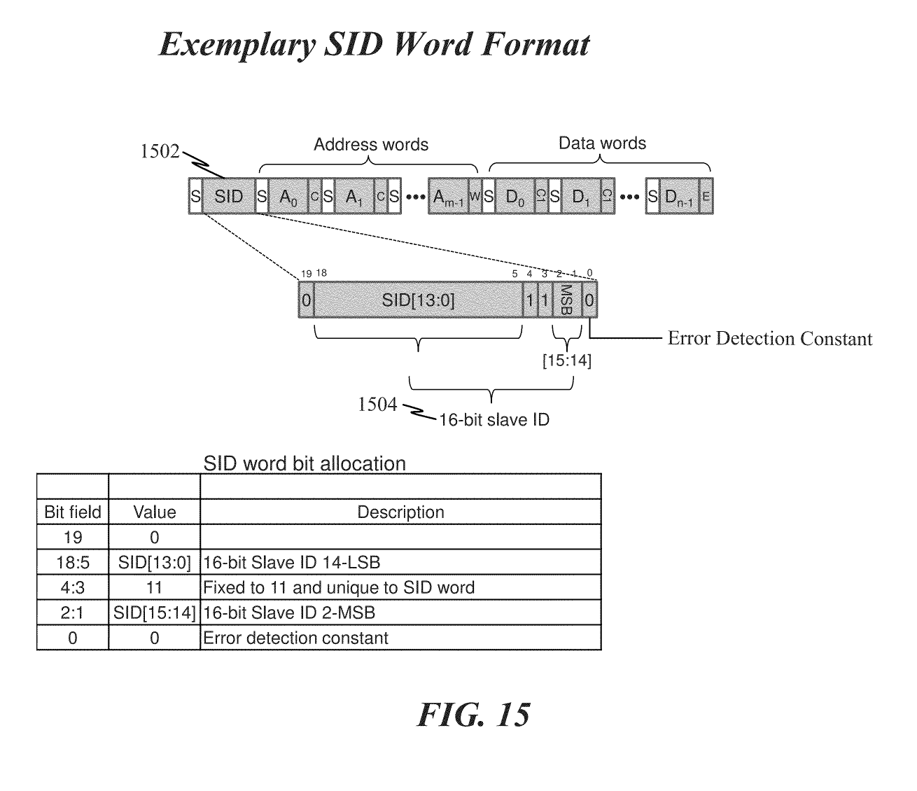

FIG. 15 illustrates an exemplary CCIe slave identifier (SID) word format. This illustrates the use of a 16-bit slave identifier (SID) 1504 as part of the CCIe SID word format 1502. Such SID word format would be used to identify a particular slave device when the word is placed on the control data bus.

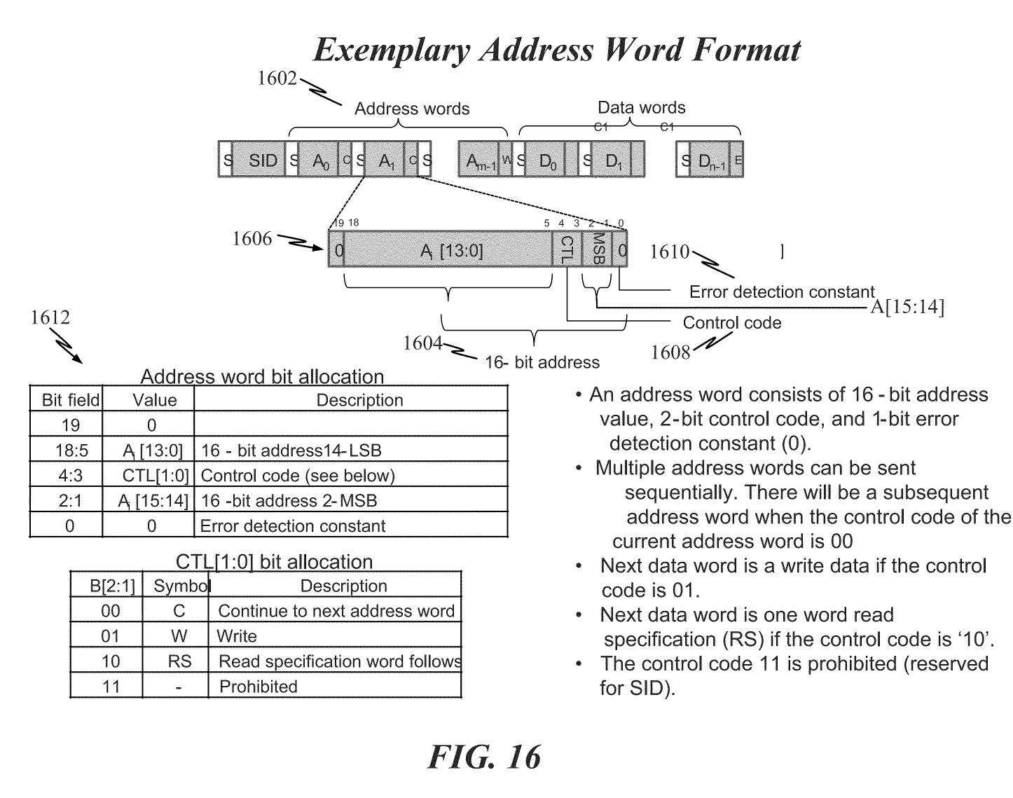

FIG. 16 illustrates an exemplary CCIe address word format 1602. This illustrates that each address word 1606 includes a 16-bit address 1604. The address word 1606 also includes a 2-bit control code 1608 and a 1-bit error detection constant 1610. The table 1612 illustrates various possible values for the control code.

Multiple address words may be sent sequentially. If the current control code is ‘00’, this means an address word will follow. If the control code is ‘01’, the next data word is a write data word. If the control code is ‘10’, the next data word is a read specification word. The control code is ‘11’ is prohibited.

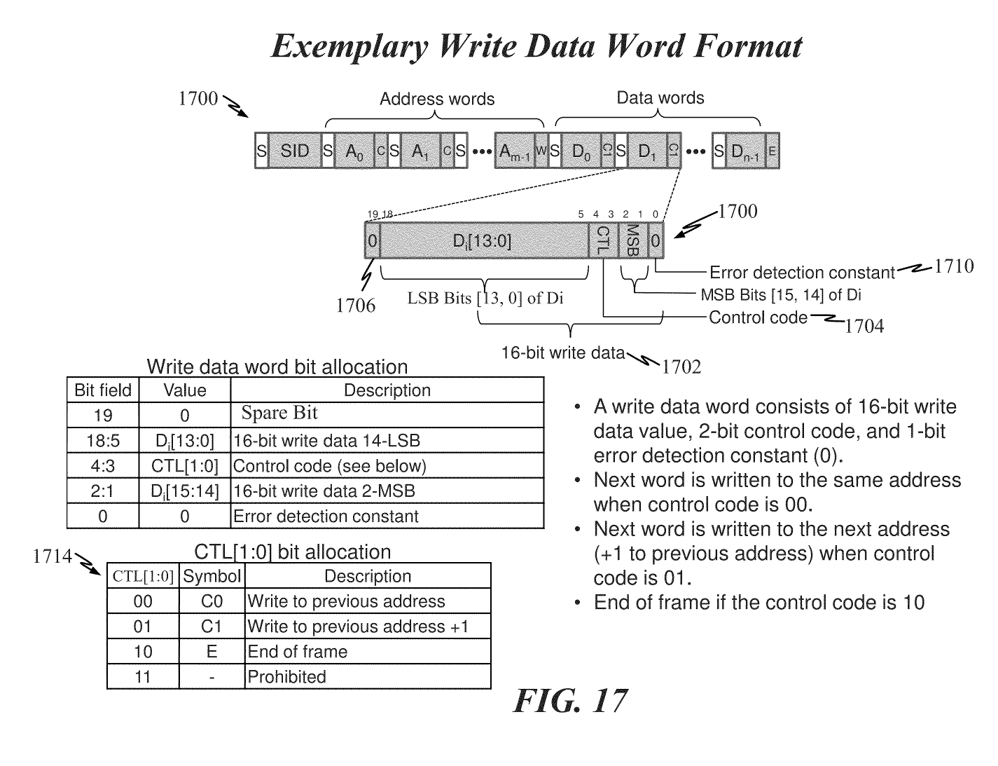

FIG. 17 illustrates an exemplary write data word format 1702. This illustrates that each write data word 1700 includes a 16-bit write data portion 1702. The write data word 1700 also includes a 2-bit control code 1704, and 1-bit error detection constant 1710. The table 1714 illustrates various possible values for the control code.

Multiple write data words can be sent sequentially. If the control code of the current write word is ‘00’ (symbol C0), then the data is to be written to the previous address. If the control code of the current write word is ‘01’ (symbol C0, then the data is to be written to the previous address+1. If the control code is ‘10’ (symbol E), the next word will be an SID or an Exit code.

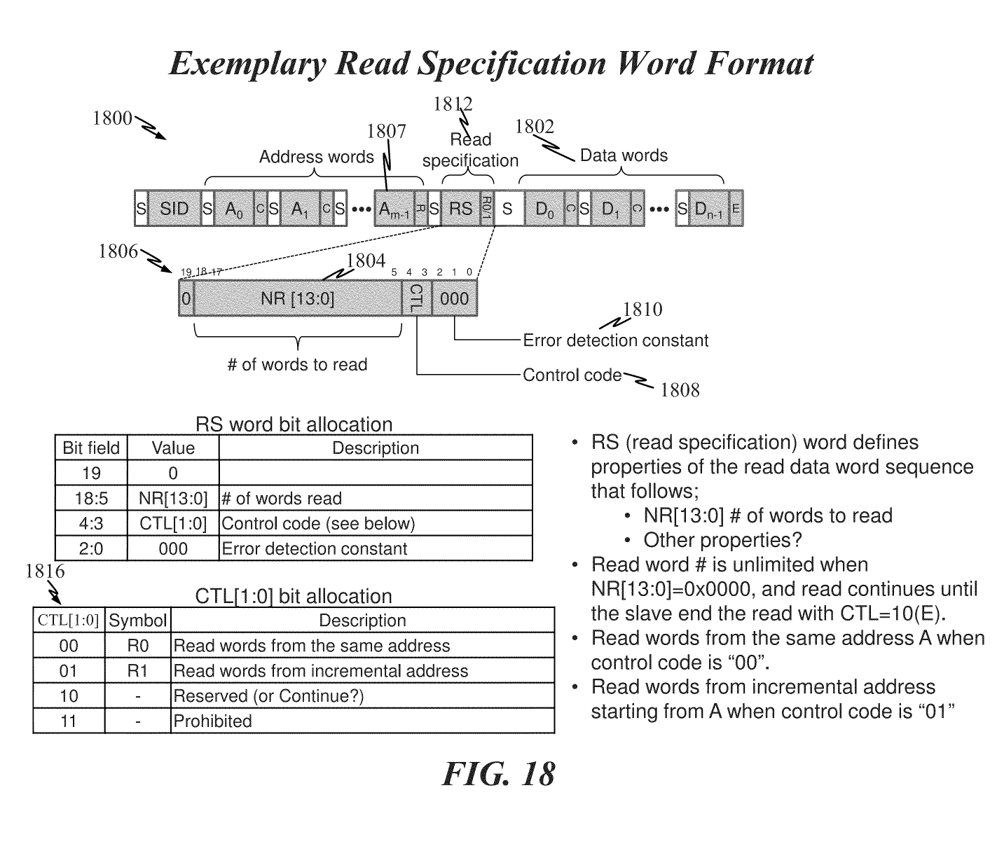

FIG. 18 illustrates an exemplary read specification word format 1800. The read specification data word 1800 may include a 16-bit read data value portion 1804, a 2-bit control code 1808, and 3-bit error detection constant 1810.

After the last address word 1807, a “read spec” (RS) word 1812 follows. The read spec (RS) word 1812 specifies the number of read data words that follow. As illustrated in the table 1816, the control code ‘00’ is used to indicate a read word from the same address. The control code ‘01’ is used to indicate a read word from an incremental address. The slave device (from where the data is being read) shall not send more data words (not including CHK words) than specified by the “read spec”(RS) word 1804. The slave device shall send at least one read word (not including CHK word). The slave device may end a read transfer before sending the number of words specified by the “read spec” (RS) 1804 word.

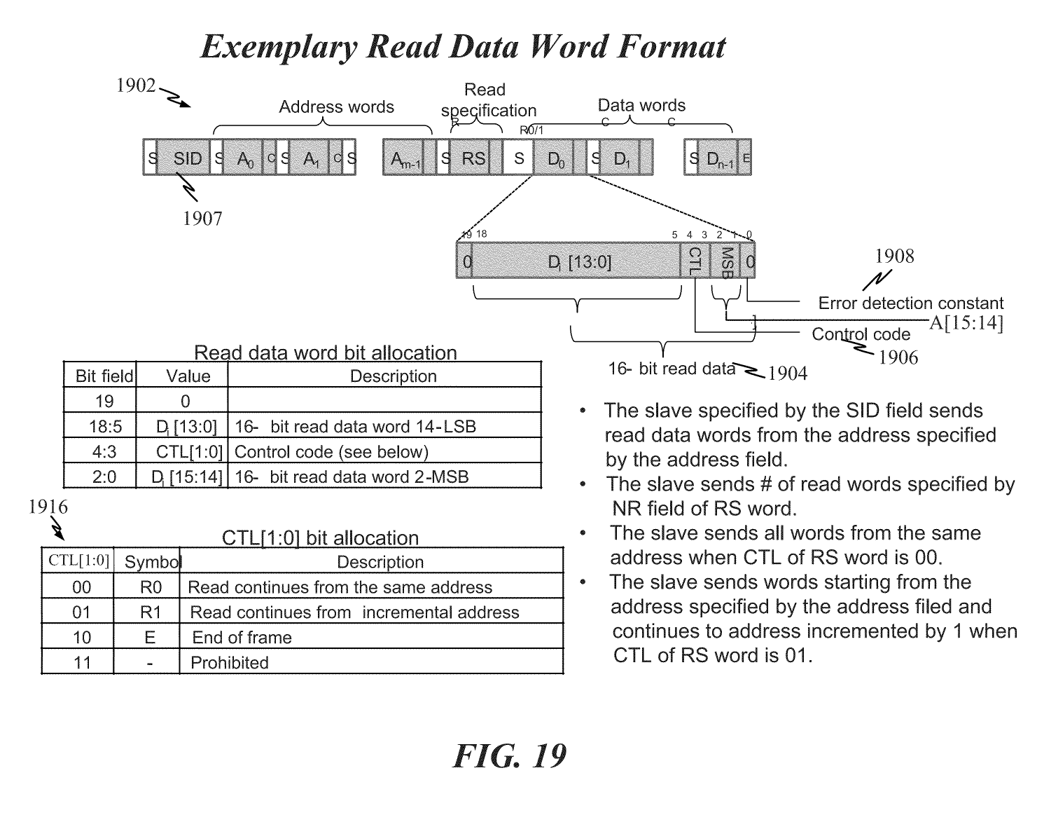

FIG. 19 illustrates an exemplary read data word format 1902. The read data word 1902 may include a 16-bit read data value portion 1904, a 2-bit control code 1906, and 1-bit error detection constant 1908. A slave device addressed by the SID 1907 determines the number of words to return to a requesting master device. As illustrated in table 1916, the control code is “00” (symbol R0) if the read word continues from the same address. Control code is “01” (symbol R1) if the read word continues from an incremental address. The control code is “10” (symbol E) if the word is the last read word and there's no CHK after that. Control code is “00” is prohibited.

### Exemplary I2C Transmissions Versus CCIe Transmissions Over Shared Bus

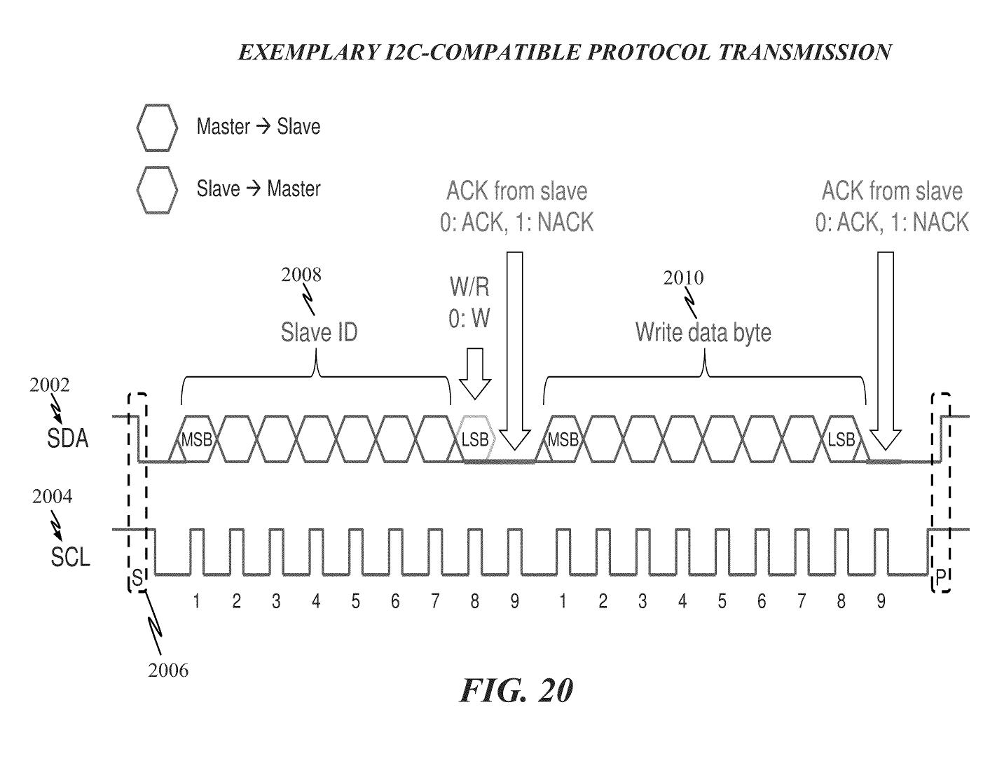

FIG. 20 illustrates an exemplary timing diagram of an I2C one byte write data operation. In this example, the shared control data bus (e.g., control data bus 308 in FIG. 3) includes a serial data line SDA 2002 and a serial clock line SCL 2004. The transmission scheme illustrated in FIG. 20 may be referred to as “I2C mode”. The SCL line 2004 is used to send a clock from the master device to all slave devices while the SDA line 2002 transmits data bits. An I2C master device sends a 7-bit slave ID 2008 in the SDA line 2002 to indicate which slave device on the I2C bus the master device wishes to access, then one bit to indicate a write operation. Only the slave device whose ID matches with the 7-bit slave ID 2008 can cause intended actions. In order for an I2C slave device to detect its own ID, the master device has to send at least 8-bits on the SDA line (or 8 clock pulses on the SCL line).

The I2C standard requires that all I2C compatible slave devices reset their bus logic on receipt of a START condition 2006 (e.g., indicated by a high-to-low transition on the SDA line while the SCL line is high).

The CCIe protocol uses both the SDA line 2002 and the SCL line 2004 for data transmissions while embedding a clock signal within the data transmissions. For example, data bits may be transcoded into a plurality of symbols which are then transmitted over lines. By embedding the clock signal (SCL line for I2C bus in FIG. 20) within symbol transitions, both the SDA line 2002 and SCL line 2004 may be used for data transmission.

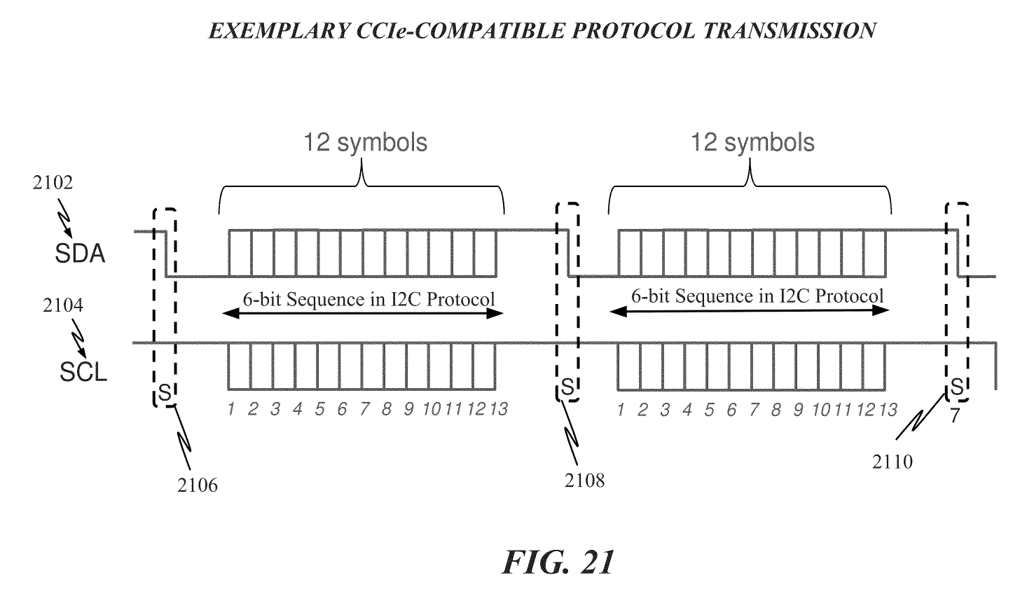

FIG. 21 illustrates an exemplary CCIe transmission in which data bits have be transcoded into twelve symbols for transmission over the SDA line 2102 and the SCL line 2104. The transmission scheme illustrated in FIG. 21 may be referred to as “CCIe mode”. CCIe mode is source synchronous, driven by push-pull drivers. Whoever sends out data over the shared control data bus also sends out clock information embedded in the data (e.g., within the symbol-to-symbol transitions). Consequently, only one device on the control data bus is allowed to drive the share control data bus at any one time.

In order to support both legacy I2C devices and CCIe devices over the same bus, CCIe mode operations use the same START condition 2106, 2108, 2110, which prevents legacy I2C slave devices from reacting to any CCIe operations (e.g., the Start condition during CCIe mode causes the legacy I2C slave devices to reset). In this example, the START condition 2106, 2108, 2110 (i.e., indicated by a high to low transition on the SDA line 2102 while the SCL line 2104 is high) is detected before a full slave ID (i.e., a full 7 bits) is transmitted, therefore this is an incomplete slave ID (less than 7 bits). If a master device sends 6 SCL pulses then issues a START condition 2106, 2108, 2110, then all legacy I2C slave devices reset their bus logic before they recognize the data as an I2C Slave ID. Since the 6-bit sequences (e.g., corresponding to every two symbols) are sent between two START conditions 2106, 2108, 2110, these G-bit sequences are not decoded as a valid slave ID by any I2C slave device. Consequently, legacy I2C slave devices will not act upon the incomplete Slave IDs.

In this system, the master device controls access to the bus. So, any device that wishes to transmit over the control data bus must request such access from the master device, for example, by issuing an interrupt request. Prior art mechanisms for issuing interrupts have relied on dedicated interrupts lines or a dedicated interrupt bus. However, such dedicated interrupt lines or bus means that the devices must include at least one additional pin to accommodate such interrupt line or bus. In order to eliminate the need for such dedicated interrupt pin and lines/bus, a mechanism for in-band interrupts within CCIe is needed.

The use of in-band interrupts should also avoid bus contention or collisions. For example, to avoid collisions, a slave device should not be allowed to drive the control data bus (e.g., either SDA line 2002 or SCL line 2104) to assert an IRQ while the master device is driving the control data bus.

### Exemplary Bit 19 Region and Checksum

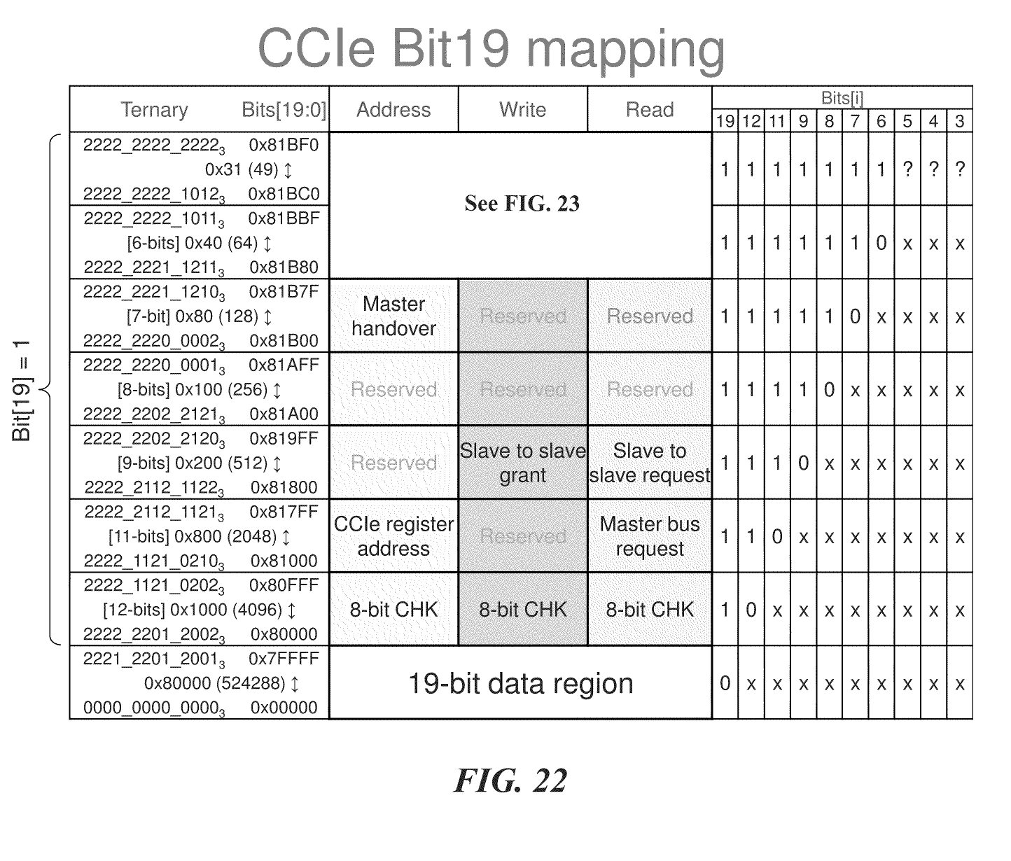

FIG. 22 illustrates an exemplary mapping of the 20^{th} bit (bit 19) resulting from the encoding scheme disclosed herein. As can be appreciated, the ternary numbers available may serve to expand the features and capabilities between master devices and slave devices. For example, this ternary number space available within bit 19 (i.e., the data region whose bit 19 is ‘1’) may serve to facilitate or indicate: (a) slave-to-slave transmissions, (b) checksums for transmissions, (c) master operation handover to slave devices, (d) a heartbeat clock, etc.

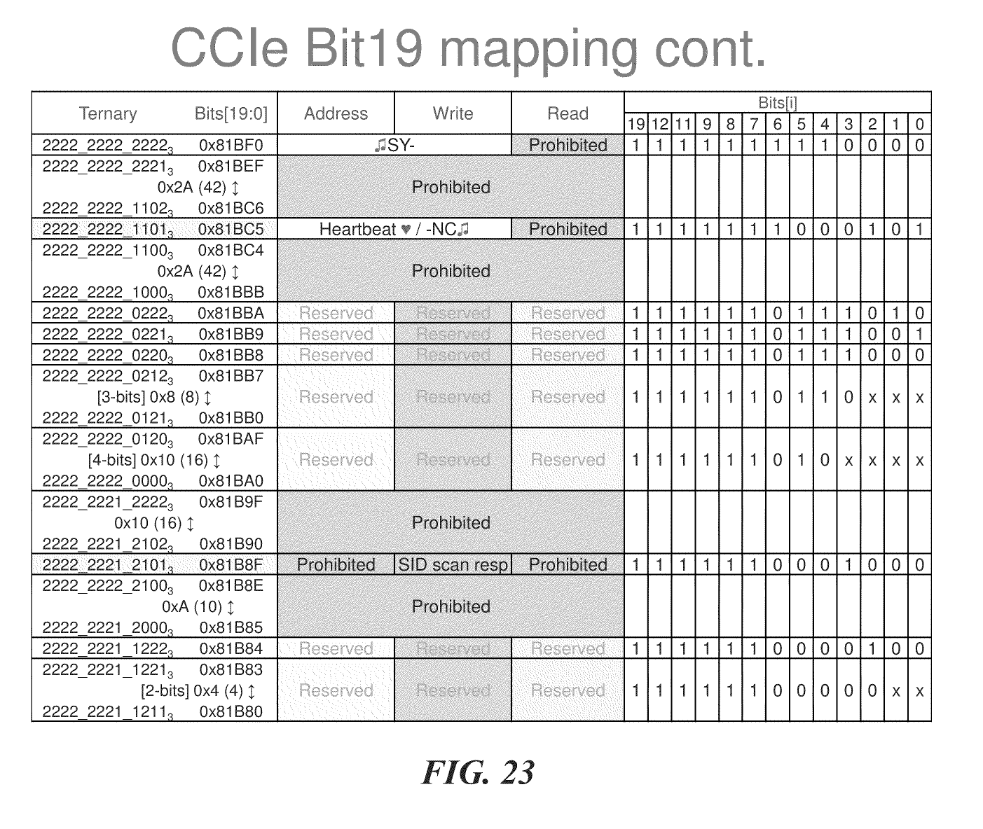

FIG. 23 illustrates details of a sub-region within the exemplary mapping of the 20^{th} bit (bit 19) region of FIG. 22.

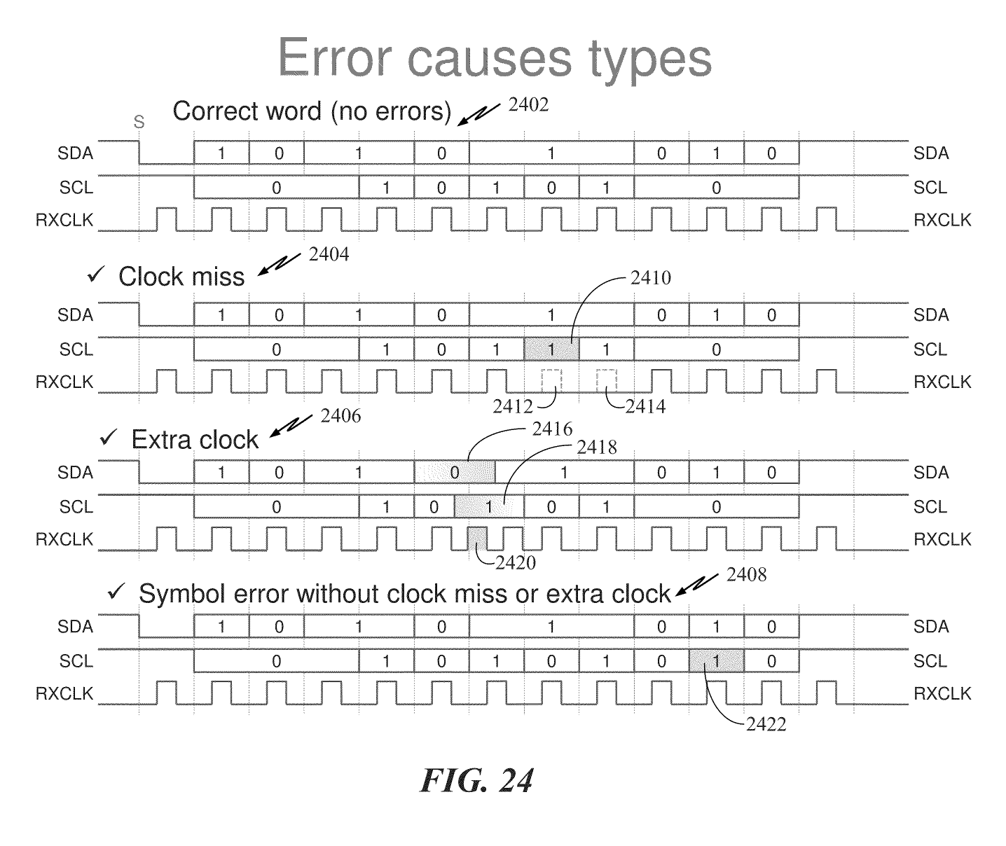

FIG. 24 illustrates various symbol error conditions that may occur. The timing diagram 2402 illustrates a correct transmission over a control data bus (SDA line and SCL line) and the receiver clock (RXCLK).

A clock miss 2404 is illustrated where the receiver clock (RXCLK) misses two cycles 2412 and 2414 such that a data bit 2410 is incorrectly detected. If there are more following words in the same transfer direction, word data errors are most likely detected following the words. Synchronization (SYNC) loss may also be detected. If the error occurs on the last word, the master device needs timeout detection functionality.

An extra clock 2406 is illustrated where the receiver clock (RXCLK) has an extra symbol ‘01’ 2416 and 2418 detected at the extra clock cycle 2420. This error is most likely detected in the word or following words. Synchronization loss may also be detected.

A symbol error 2408 is illustrated where there are no receiver clock (RXCLK) misses but a single symbol error 2422 occurs. This error is most likely detected in the word or following words. A checksum error is most likely detected.

Exemplary Error Detection within Transmitted Symbols

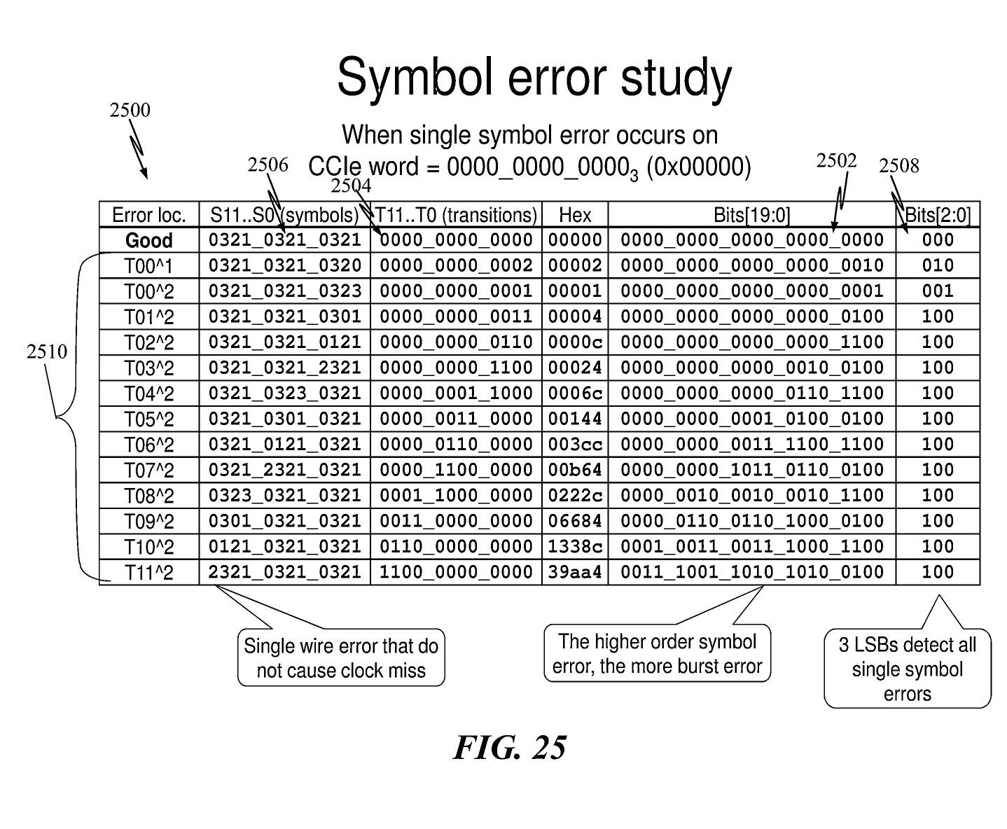

FIGS. 25-30 illustrate various symbol error conditions (i.e., single symbol error without a symbol slip) that may occur for various CCIe words. As shown, these errors may be detected by using three bits (bits 0, 1, and 2), as discussed further below. These examples use the three (3) least significant bits (Bits [2:0]) for error detection.

FIG. 25 illustrates a table 2500 showing the possible errors in the transmitted symbol sequence 0321_{—}0321_{—}0321 and how such errors are detectable within the three least significant bits. A twenty bit sequence of (Bits [19:0]) 0000_{—}0000_{—}0000_{—}0000_{—}0000 2502 is converted into a ternary number (T11 . . . T0) 0000_{—}0000_{—}0000₃ 2504 which is then converted to sequential symbols (S11 . . . S0) 0321_{—}0321_{—}0321 2506 by using the method illustrated in FIGS. 5, 6, 7, 8, 9, and 10. For purposes of this example, the three least significant bits 2508 are all zero (000). If an error is introduced during transmission at any of the symbols of the original sequential symbols 0321_{—}0321_{—}0321 2506, these results in erroneous symbols 2510. For example, if the last symbol “1” is changed to “0”, this results in a change of the three least significant bits from “000” to “010”. If the last symbol “1” is changed to “3”, this results in a change of the three least significant bits from “000” to “001”. If the first symbol of “0” is changed to “2”, this results in a change of the three least significant bits from “000” to “100”. The table 2500 illustrates various other examples of how a change of any single symbol is detectable by the three (3) least significant bits, so long as the least three significant bits are a known constant (e.g., a fixed constant of “000”).

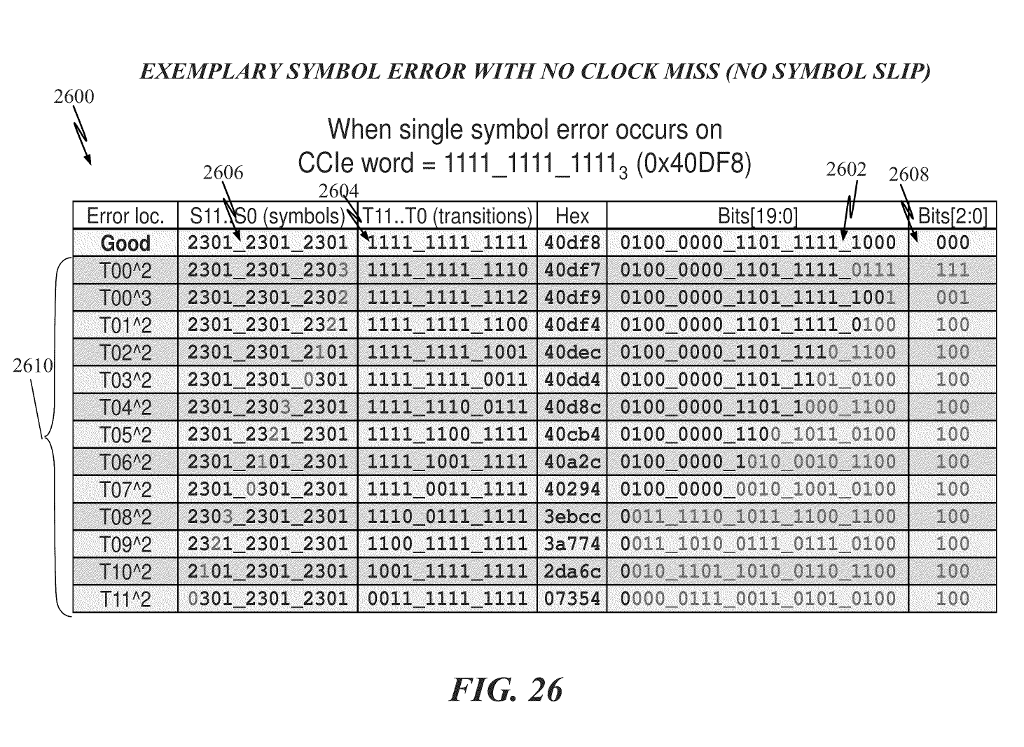

FIG. 26 illustrates a table 2600 showing the possible errors in the transmitted symbol sequence 2301_{—}2301_{—}2301 and how such errors are detectable within the three least significant bits. A twenty bit sequence of (Bits [19:0]) 0100_{—}0000_{—}1101_{—}1111_{—}1000 2602 is converted into a ternary number (T11 . . . T0) 1111_{—}1111_{—}1111₃ 2604 which is then converted to sequential symbols (S11 . . . S0) 2301_{—}2301_{—}2301 2606 by using the method illustrated in FIGS. 5, 6, 7, 8, 9, and 10. For purposes of this example, the three least significant bits 2608 are all zero (000). If an error is introduced during transmission at any of the symbols of the original sequential symbols 2301_{—}2301_{—}2301 2606, these results in erroneous symbols 2610. For example, if the last symbol “1” is changed to “3”, this results in a change of the three least significant bits from “000” to “111”. If the last symbol “1” is changed to “2”, this results in a change of the three least significant bits from “000” to “001”. If the first symbol of “2” is changed to “0”, this results in a change of the three least significant bits from “000” to “100”. The table 2600 illustrates various other examples of how a change of any single symbol is detectable by the three (3) least significant bits, so long as the least three significant bits are a known constant (e.g., a fixed constant of “000”).

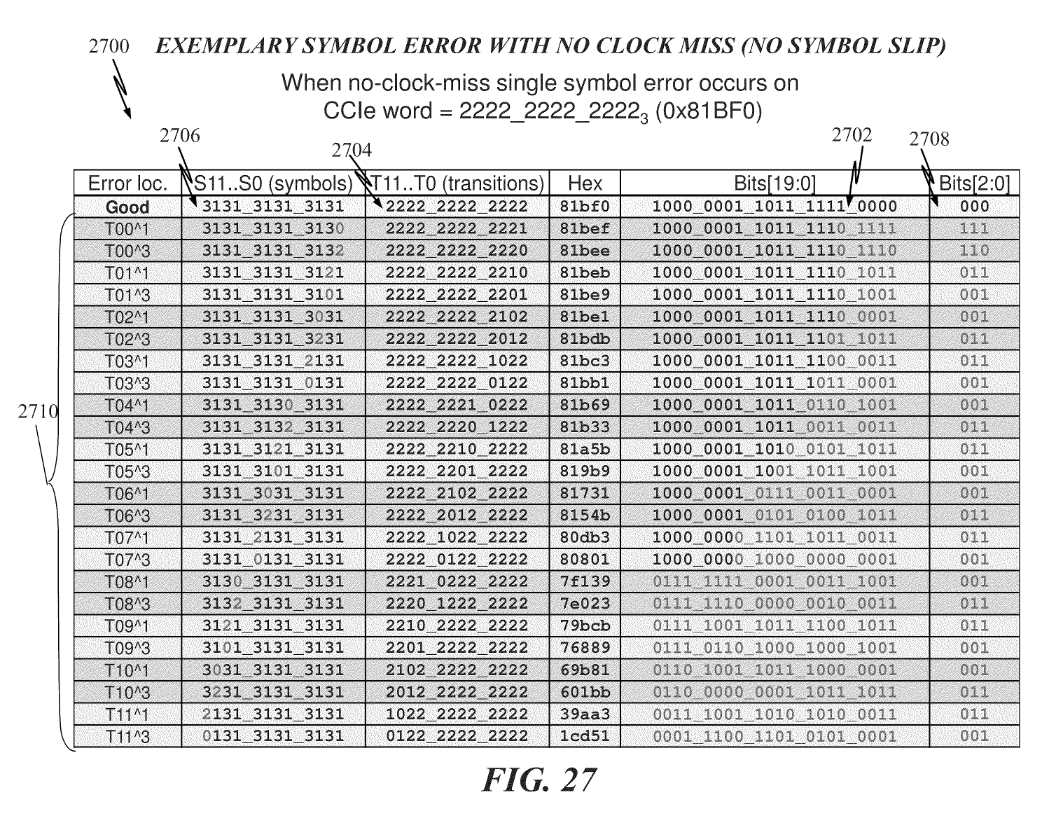

FIG. 27 illustrates a table 2700 showing the possible errors in the transmitted symbol sequence 3131_{—}3131_{—}3131 and how such errors are detectable within the three least significant bits. A twenty bit sequence of (Bits [19:0]) 1000_{—}0001_{—}1011_{—}1111_{—}0000 2702 is converted into a ternary number (T11 . . . T0) 2222_{—}2222_{—}2222₃ 2704 which is then converted to sequential symbols (S11 . . . S0) 3131_{—}3131_{—}3131 2706 by using the method illustrated in FIGS. 5, 6, 7, 8, 9, and 10. For purposes of this example, the three least significant bits 2708 are all zero (000). If an error is introduced during transmission at any of the symbols of the original sequential symbols 3131_{—}3131_{—}3131 2706, these results in erroneous symbols 2710. For example, if the last symbol “1” is changed to “0”, this results in a change of the three least significant bits from “000” to “111”. If the last symbol “1” is changed to “2”, this results in a change of the three least significant bits from “000” to “100”. If the first symbol of “3” is changed to “0”, this results in a change of the three least significant bits from “000” to “001”. The table 2700 illustrates various other examples of how a change of any single symbol is detectable by the three (3) least significant bits, so long as the least three significant bits are a known constant (e.g., a fixed constant of “000”).

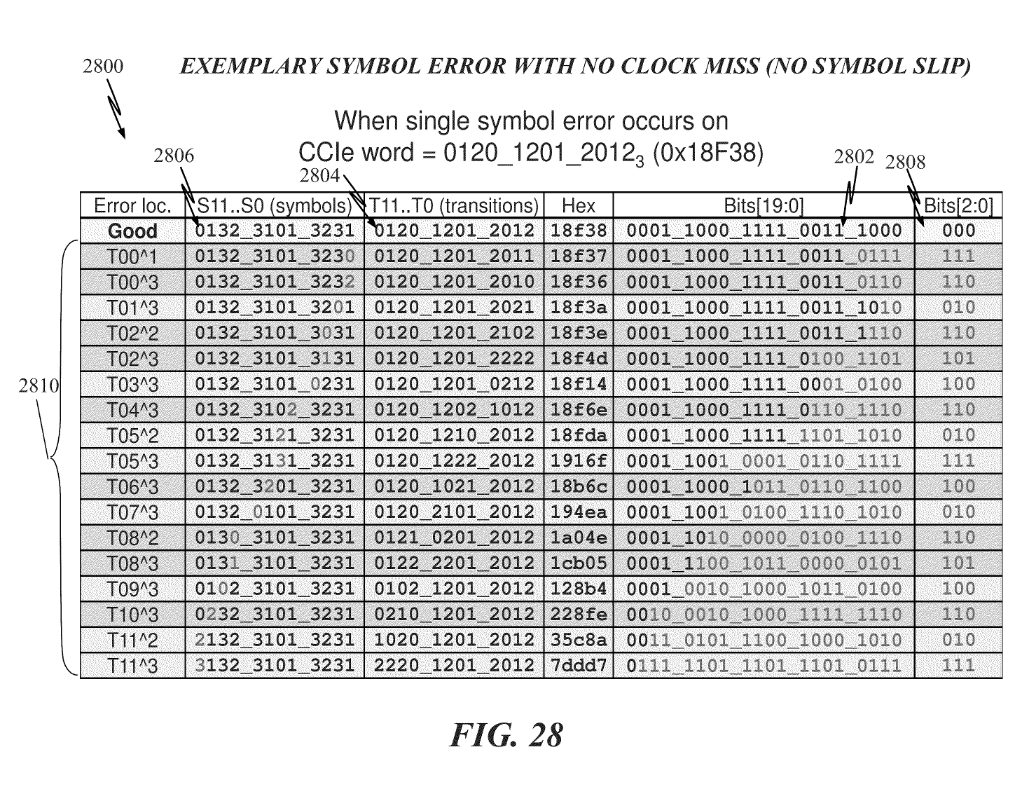

FIG. 28 illustrates a table 2800 showing the possible errors in the transmitted symbol sequence 0132_{—}3101_{—}3231 and how such errors are detectable within the three least significant bits. A twenty bit sequence of (Bits [19:0]) 0001_{—}1000_{—}1111_{—}0011_{—}1000 2802 is converted into a ternary number (T11 . . . T0) 0120_{—}1201_{—}2012₃ 2804 which is then converted to sequential symbols (S11 . . . S0) 0132_{—}3101_{—}3231 2806 by using the method illustrated in FIGS. 5, 6, 7, 8, 9, and 10. For purposes of this example, the three least significant bits 2808 are all zero (000). If an error is introduced during transmission at any of the symbols of the original sequential symbols 0132_{—}3101_{—}3231 2806, these results in erroneous symbols 2810. For example, if the last symbol “1” is changed to “0”, this results in a change of the three least significant bits from “000” to “111”. If the last symbol “1” is changed to “2”, this results in a change of the three least significant bits from “000” to “110”. If the first symbol of “0” is changed to “3”, this results in a change of the three least significant bits from “000” to “111”. The table 2800 illustrates various other examples of how a change of any single symbol is detectable by the three (3) least significant bits, so long as the least three significant bits are a known constant (e.g., a fixed constant of “000”).

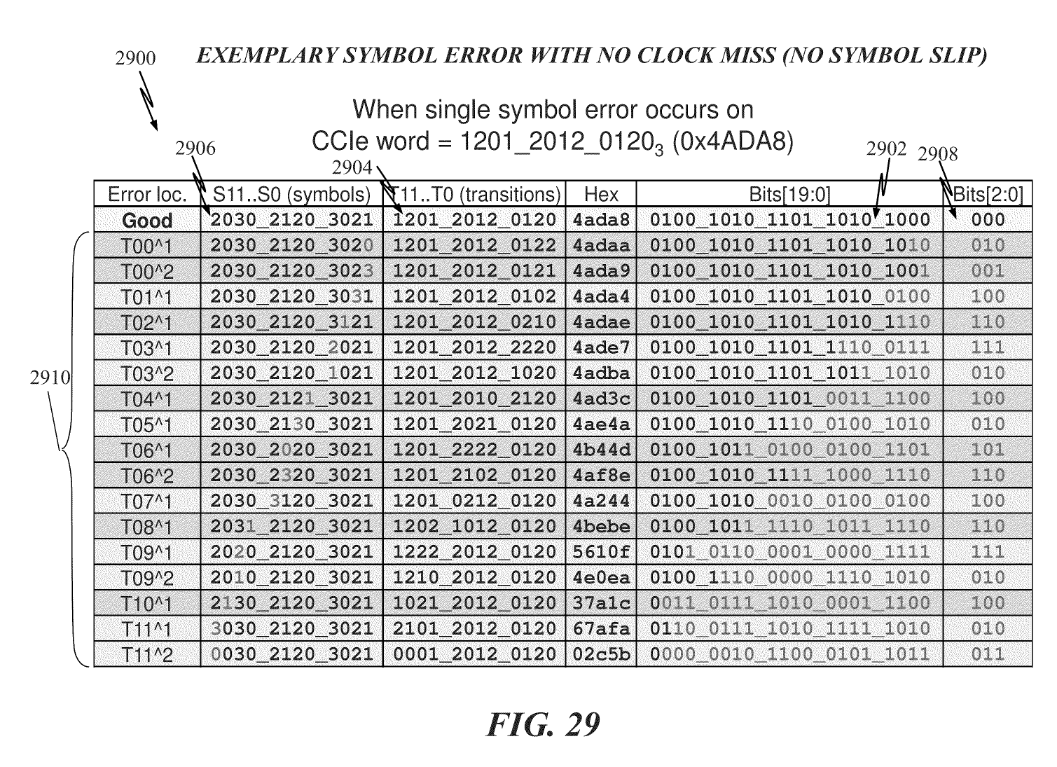

FIG. 29 illustrates a table 2900 showing the possible errors in the transmitted symbol sequence 2030_{—}2120_{—}3021 and how such errors are detectable within the three least significant bits. A twenty bit sequence of (Bits [19:0]) 0100_{—}1010_{—}1101_{—}1010_{—}1000 2902 is converted into a ternary number (T11 . . . T0) 1201_{—}2012_{—}0120₃ 2904 which is then converted to sequential symbols (S11 . . . S0) 2030_{—}2120_{—}3021 2906 by using the method illustrated in FIGS. 5, 6, 7, 8, 9, and 10. For purposes of this example, the three least significant bits 2908 are all zero (000). If an error is introduced during transmission at any of the symbols of the original sequential symbols 3231_{—}0132_{—}3101 2906, these results in erroneous symbols 2910. For example, if the last symbol “1” is changed to “0”, this results in a change of the three least significant bits from “000” to “010”. If the first symbol of “2” is changed to “0”, this results in a change of the three least significant bits from “000” to “011”. The table 2900 illustrates various other examples of how a change of any single symbol is detectable by the three (3) least significant bits, so long as the least three significant bits are a known constant (e.g., a fixed constant of “000”).

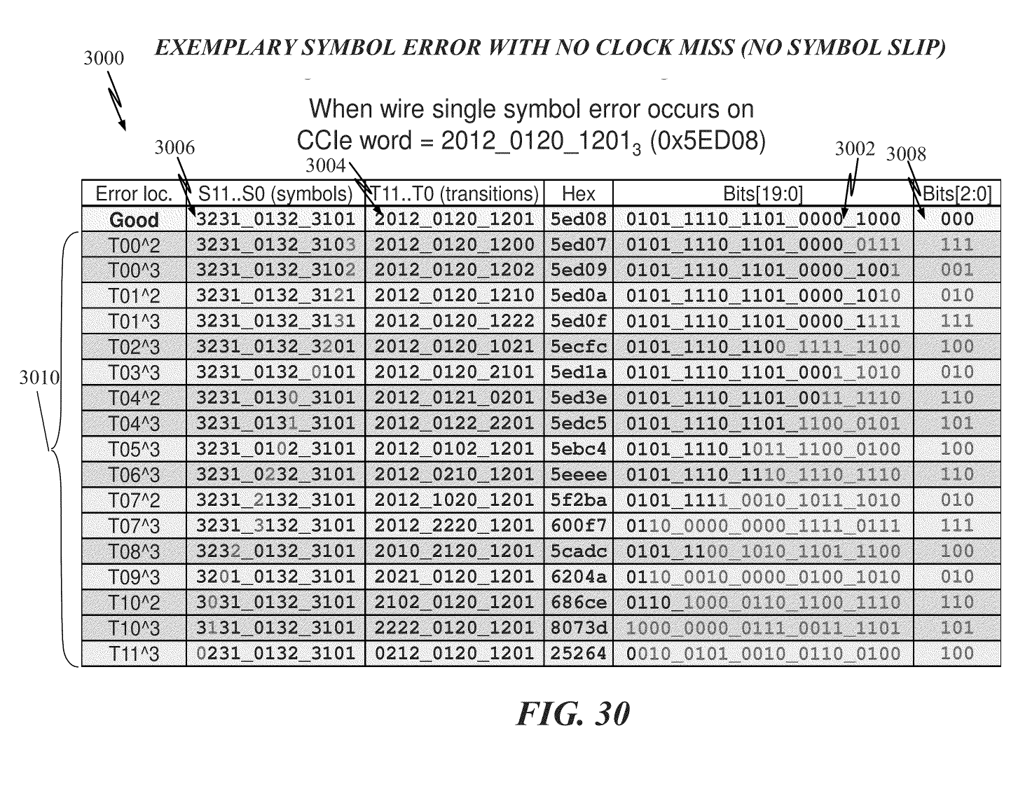

FIG. 30 illustrates a table 3000 showing the possible errors in the transmitted symbol sequence 3231_{—}0132_{—}3101 and how such errors are detectable within the three least significant bits. A twenty bit sequence of (Bits [19:0]) 0101_{—}1110_{—}1101_{—}0000_{—}1000 3002 is converted into a ternary number (T11 . . . T0) 2012_{—}0120_{—}1201₃ 3004 which is then converted to sequential symbols (S11 . . . S0) 3231_{—}0132_{—}3101 3006 by using the method illustrated in FIGS. 5, 6, 7, 8, 9, and 10. For purposes of this example, the three least significant bits 3008 are all zero (000). If an error is introduced during transmission at any of the symbols of the original sequential symbols 3231_{—}0132_{—}3101 3006, these results in erroneous symbols 3010. For example, if the last symbol “1” is changed to “3”, this results in a change of the three least significant bits from “000” to “111”. If the first symbol of “3” is changed to “0”, this results in a change of the three least significant bits from “000” to “100”. The table 3000 illustrates various other examples of how a change of any single symbol is detectable by the three (3) least significant bits, so long as the least three significant bits are a known constant (e.g., a fixed constant of “000”).

### Exemplary Master/Slave Device Implementations

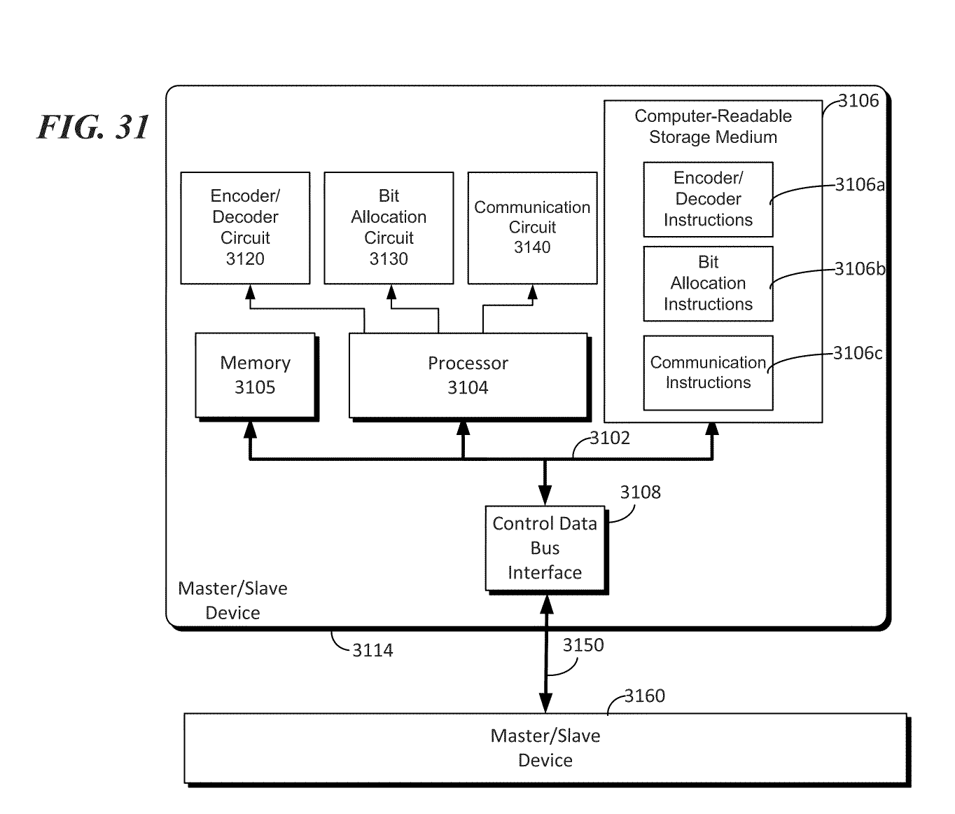

Referring next to FIG. 31, a block diagram illustrating exemplary components of a master/slave device is provided in accordance with the disclosure. As illustrated, a master/slave device 3114 is coupled to another master/slave device 3160 via a control data bus 3150. Here, it is contemplated that either of the master/slave devices 3114 or 3160 may operate as a master or slave in accordance with the aforementioned aspects disclosed herein, and that each of the master/slave devices 3114 and 3160 may have substantially similar components.

In this example, the master/slave device 3114 may be implemented with an internal bus architecture, represented generally by the bus 3102. The bus 3102 may include any number of interconnecting busses and bridges depending on the specific application of the master/slave device 3114 and the overall design constraints. The bus 3102 links together various circuits including one or more processors (represented generally by the processor 3104), a memory 3105, and computer-readable media (represented generally by the computer-readable medium 3106). The bus 3102 may also link various other circuits such as timing sources, peripherals, voltage regulators, and power management circuits, which are well known in the art, and therefore, will not be described any further.

In a particular implementation, a control data bus interface 3108 provides an interface between a control data bus 3150 and the master/slave device 3114, wherein the processor 3104 is configured to facilitate an encoded communication of a word between the master/slave device 3114 and the master/slave device 3160 via the control data bus 3150. Here, it is contemplated that the control data bus 3150 may be a two-line bus, and that the encoded communication may be encoded according to a protocol (e.g., a CCIe protocol) that allocates a plurality of least significant bits of the encoded communication to facilitate maximizing an error detection constant. As previously mentioned, such maximization may be achieved via a protocol that allocates the plurality of least significant bits to include at least one additional error detection bit or at least a first most significant bit of a data portion of the word.

In a further aspect of the disclosure, the computer-readable medium 3106 is configured to include various instructions 3106a, 3106b, and/or 3106c to facilitate an error detection optimization over the control data bus 3150 as disclosed herein. Similarly, such aspects can instead be implemented via hardware by coupling the processor 3104 to any of the illustrated circuits 3120, 3130, and/or 3140, as shown. Moreover, it is contemplated that an error detection optimization over the control data bus 3150 may be facilitated by any combination of the instructions 3106a, 3106b, and/or 3106c, as well as any combination of the circuits 3120, 3130, and/or 3140.

For instance, the encoder/decoder instructions 3106a and the encoder/decoder circuit 3120 are directed towards encoding/decoding words according to a selected/detected protocol (e.g., a CCIe protocol). As previously mentioned, such encoding/decoding may comprise converting a ternary number into a plurality of symbols on a digit by digit basis (e.g., a twelve digit ternary number results in twelve symbols) to yield the aforementioned “extra bit”.

In another aspect of the disclosure, the bit allocation instructions 3106b and the bit allocation circuit 3130 are directed towards allocating bits in accordance with a desired word format (e.g., an SID word format, an address word format, a write data word format, a read specification word format, or a read data word format). To this end, various contemplated word formats disclosed herein comprise 20-bit word formats, wherein the three least significant bits are allocated to facilitate maximizing an error detection constant. Moreover, it is contemplated that either of the bit allocation instructions 3106b and/or the bit allocation circuit 3130 may be configured to facilitate a flexible bit allocation scheme to facilitate such maximization according to whether an error detection optimization or data optimization is desired. For instance, in a particular implementation, a least significant bit is allocated for error detection, and each of a second least significant bit and a third least significant bit are allocated for either additional error detection bits or the two most significant bits of the data portion of a word.

In another aspect of the disclosure, communication instructions 3106c and/or communication circuit 3140 may be configured to interface the master/slave device 3114 with the control data bus 3150. In particular, either of communication instructions 3106c and/or communication circuit 3140 may be configured to facilitate an encoded communication of a word between the master/slave device 3114 device and the master/slave device 3160 in accordance with a protocol (e.g., a CCIe protocol) that facilitates the error detection optimization disclosed herein.

Referring back to the remaining elements of FIG. 31, it should be appreciated that processor 3104 is responsible for managing the bus 3102 and general processing, including the execution of software stored on the computer-readable medium 3106. The software, when executed by the processor 3104, causes the master/slave device 3114 to perform the various functions described below for any particular apparatus. The computer-readable medium 3106 may also be used for storing data that is manipulated by the processor 3104 when executing software.

One or more processors 3104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 3106. The computer-readable medium 3106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 3106 may reside in the master/slave device 3114, external to the master/slave device 3114, or distributed across multiple entities including the master/slave device 3114. The computer-readable medium 3106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

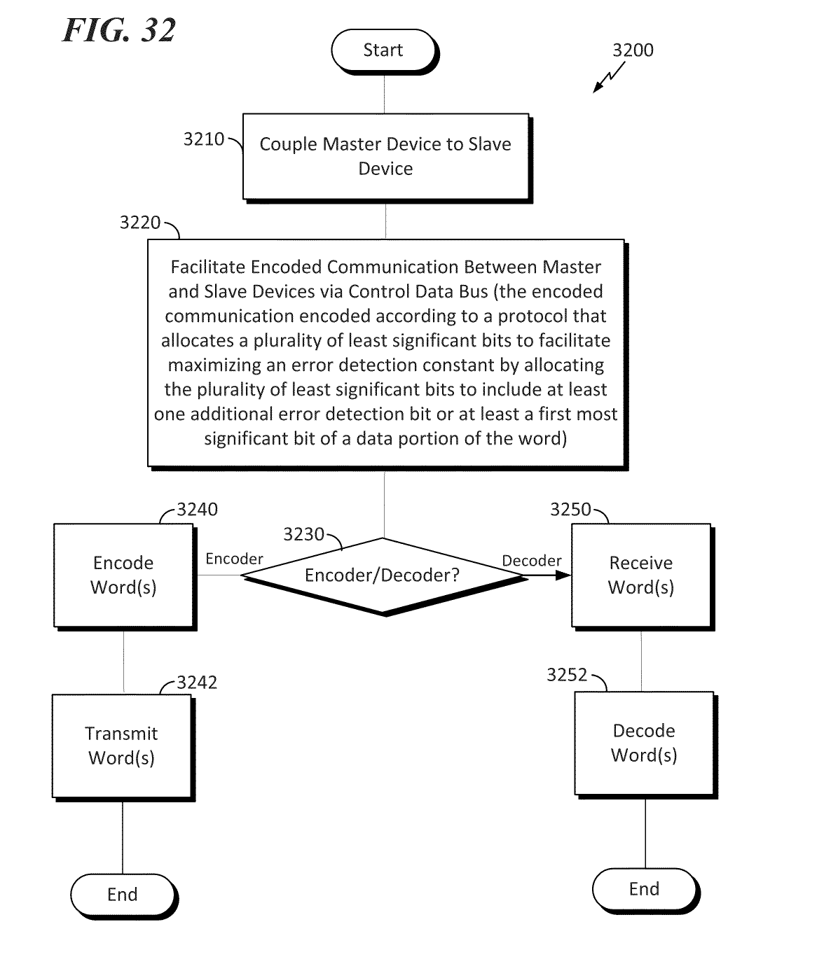

Referring next to FIG. 32, a flow chart illustrating an exemplary method that facilitates an error detection optimization over a shared bus in accordance with aspects disclosed herein is provided. As illustrated, process 3200 includes a series of acts that may be performed within a computing device (e.g., master/slave device 3114) according to an aspect of the subject specification. For instance, process 3200 may be implemented by employing a processor to execute computer executable instructions stored on a computer readable storage medium to implement the series of acts. In another embodiment, a computer-readable storage medium comprising code for causing at least one computer to implement the acts of process 3200 is contemplated.

As illustrated, process 3200 begins with coupling a master device to a slave device at act 3210. Here, it should be appreciated that such coupling may comprise connecting the master and slave devices via a control data bus. Process 3200 then proceeds to act 3220 where an encoded communication of a word between the master and slave devices via the control data bus is facilitated (e.g., selecting a desired protocol, desired word format, etc.). Here, it is contemplated that the encoded communication is encoded according to a protocol that allocates a plurality of least significant bits of the encoded communication to facilitate maximizing an error detection constant by allocating the plurality of least significant bits to include at least one additional error detection bit or at least a first most significant bit of a data portion of the word. Since both encoding and decoding aspects are contemplated, process 3200 may further comprise determining, at act 3230, whether to proceed with an encoder operation or a decoder operation. For instance, when operating as an encoder, process 3200 may proceed to act 3240 where words are encoded according to a protocol (e.g., a CCIe protocol) that allocates a plurality of least significant bits of the encoded communication to facilitate maximizing an error detection constant in accordance with the aspects disclosed herein, and subsequently conclude at act 3242 where the encoded communication is transmitted via the control data bus. Otherwise, if operating as a decoder, process 3200 may proceed to act 3250 where an encoded communication is received via the control data bus, and subsequently conclude at act 3252 where the encoded communication is decoded according to a protocol (e.g., a CCIe protocol) that facilitates the error detection optimization disclosed herein.

### Exemplary Encoder Implementations

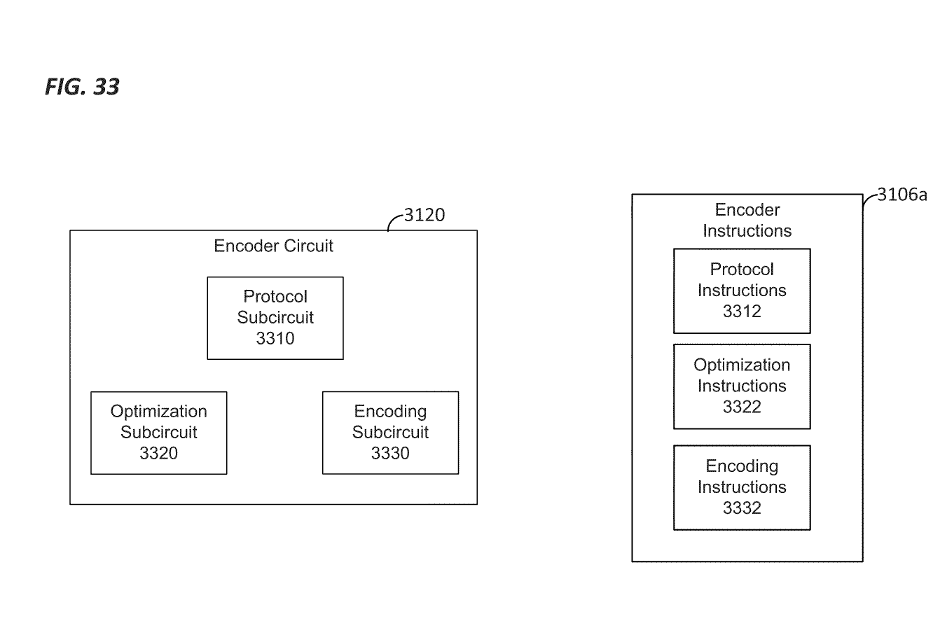

Referring back to FIG. 31, exemplary implementations are now discussed within the context of configuring the master/slave device 3114 as an encoder. To facilitate such implementation, it is contemplated that the encoder/decoder circuit 3120 may be configured as an encoder circuit and that the encoder/decoder instructions 3106a may be configured as encoder instructions. To this end, as illustrated in FIG. 33, it is further contemplated that each of the encoder circuit 3120 and the encoder instructions 3106a may be configured to facilitate an encoding of words according to the aspects disclosed herein via any of a plurality of subcomponents. Namely, as illustrated in FIG. 33, the encoder circuit 3120 may comprise protocol sub-circuit 3310, optimization sub-circuit 3320, and encoding sub-circuit 3330, whereas the encoder instructions 3106a may comprise protocol instructions 3312, optimization instructions 3322, and encoding instructions 3332. For this particular implementation, each of the bit allocation circuit 3130 and the bit allocation instructions 3106b are directed towards allocating bits according to a bit allocation scheme, wherein the bit allocation scheme allocates a plurality of least significant bits of the encoded communication to facilitate maximizing an error detection constant. Each of the protocol sub-circuit 3310 and the protocol instructions 3312 are then directed towards determining a word format of the word associated with a desired protocol (e.g., a CCIe protocol), whereas each of the encoding sub-circuit 3330 and the encoding instructions 3332 are directed towards encoding words according to the aforementioned word format and bit allocation scheme to generate the encoded communication (e.g., by encoding words as encoded ternary numbers transcoded into symbols). Once the words are encoded, either of the communication circuit 3140 and/or the communication instructions 3106c may be used to transmit the encoded communication via the control data bus.

In a further aspect of the disclosure, it is contemplated that either of the optimization sub-circuit 3320 and/or the optimization instructions 3322 may be configured to ascertain an optimization to implement via the desired word format and corresponding bit allocation scheme. In a particular implementation, the optimization sub-circuit 3320 and/or the optimization instructions 3322 may be configured to facilitate switching between an encoding of words according to an error detection optimization having a first bit allocation scheme, and an encoding of words according to a data optimization having a second bit allocation scheme. For instance, when an error detection optimization is preferred over a data optimization, the encoding sub-circuit 3330 and/or the encoding instructions 3332 may be configured to encode words according to an error detection optimization in which the plurality of least significant bits comprises a fixed number of three bits (e.g., the three least significant bits), wherein the bit allocation circuit 3130 and/or the bit allocation instructions 3106b are configured to facilitate the error detection optimization by allocating each of a least significant bit, a second least significant bit, and a third least significant bit for error detection. When a data optimization is preferred over an error detection optimization, however, the encoding sub-circuit 3330 and/or the encoding instructions 3332 may instead be configured to encode words according to a data optimization in which the plurality of least significant bits comprises a fixed number of three bits, wherein the bit allocation circuit 3130 and/or the bit allocation instructions 3106b are configured to facilitate the data optimization by allocating a least significant bit for error detection, a second least significant bit for the most significant bit of a data portion of the word, and a third least significant bit for the second most significant bit of the data portion of the word.

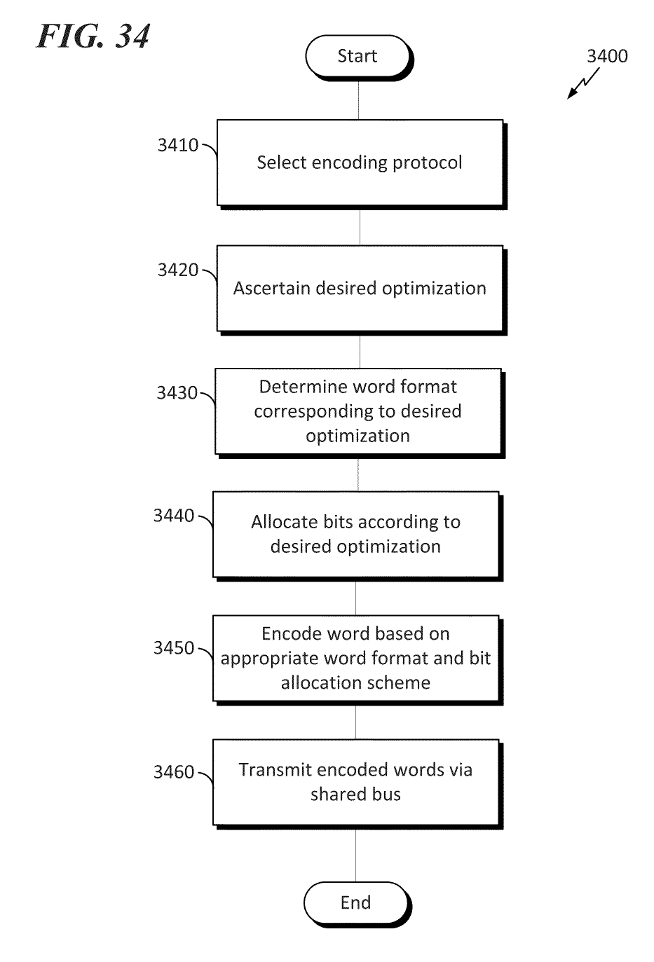

Referring next to FIG. 34, a flow chart illustrating an exemplary encoding methodology is provided in accordance with aspects disclosed herein. As illustrated, process 3400 includes a series of acts that may be performed within a computing device (e.g., master/slave device 3114) according to an aspect of the subject specification. For instance, process 3400 may be implemented by employing a processor to execute computer executable instructions stored on a computer readable storage medium to implement the series of acts. In another embodiment, a computer-readable storage medium comprising code for causing at least one computer to implement the acts of process 3400 is contemplated.

As illustrated, process 3400 begins with the selection of an encoding protocol (e.g., a CCIe protocol) at act 3410. Process 3400 then proceeds to act 3420 where the master/slave device ascertains a desired optimization to implement via the selected protocol, wherein an appropriate word format for the desired optimization is then determined at act 3430, and wherein bits are subsequently allocated according to the desired optimization at act 3440. For instance, where maximum symbol error detection is desired, act 3430 may comprise utilizing a twenty bit CCIe word format, and act 3440 may comprise allocating the three least significant bits of such format for an error detection constant. Otherwise, if data throughput optimization is desired, act 3430 may again comprise utilizing a twenty bit CCIe word format, but act 3440 may now comprise allocating only the least significant bit for the error detection constant, whereas the second least significant bit is allocated for the most significant bit of a data portion of the word, and the third least significant bit is allocated for the second most significant bit of the data portion of the word.

Once the proper bit allocation is performed at act 3440, process 3400 proceeds to act 3450 where words are encoded in accordance with the word format and bit allocation scheme of the desired optimization. Here, as previously mentioned, such encoding may comprise encoding words as encoded ternary numbers transcoded into symbols. Process 3400 then concludes at act 3460 where the encoded communication is transmitted via a control data bus to other master/slave devices.

### Exemplary Decoder Implementations

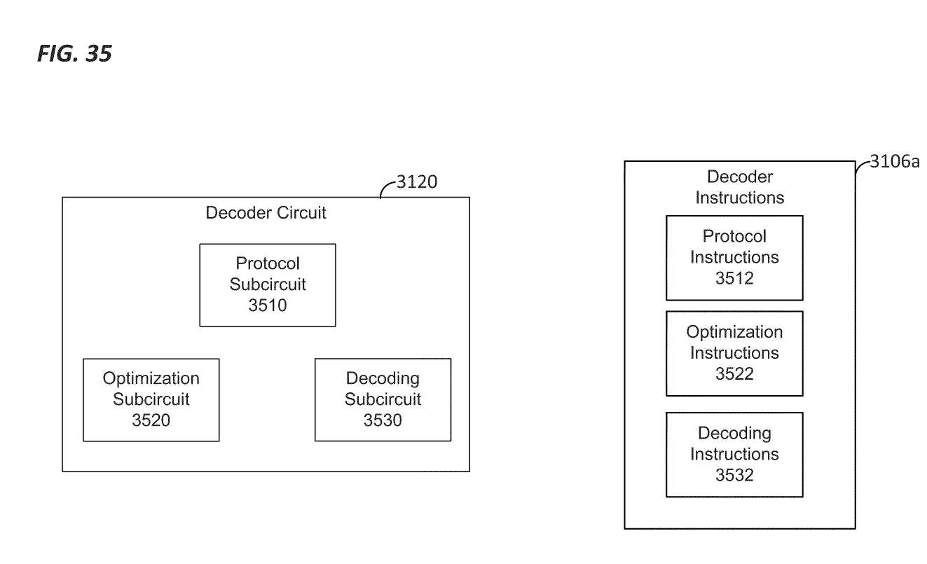

Referring back to FIG. 31, exemplary implementations are now discussed within the context of configuring the master/slave device 3114 as a decoder. To facilitate such implementation, it is contemplated that the encoder/decoder circuit 3120 may be configured as a decoder circuit and that the encoder/decoder instructions 3106a may be configured as decoder instructions. To this end, as illustrated in FIG. 35, it is further contemplated that each of the decoder circuit 3120 and the decoder instructions 3106a may be configured to facilitate a decoding of words according to the aspects disclosed herein via any of a plurality of subcomponents. Namely, as illustrated in FIG. 35, the decoder circuit 3120 may comprise protocol sub-circuit 3510, optimization sub-circuit 3520, and decoding sub-circuit 3530, whereas the decoder instructions 3106a may comprise protocol instructions 3512, optimization instructions 3522, and decoding instructions 3532. For this particular implementation, either of the communication circuit 3140 and/or the communication instructions 3106c may be configured to receive an encoded communication via a control data bus, whereas the decoder circuit 3120 and/or the decoder instructions 3106a may be configured to facilitate a decoding of the encoded communication. Each of the protocol sub-circuit 3510 and the protocol instructions 3512 are then directed towards detecting a word format of a word included in the encoded communication associated with a protocol (e.g., a CCIe protocol), and each of the optimization sub-circuit 3520 and the optimization instructions 3522 are configured to ascertain an optimization of the encoded communication and a bit allocation scheme corresponding to the optimization. The decoding sub-circuit 3530 and the decoding instructions 3532 may then be configured to decode the encoded communication according to the appropriate word format and corresponding bit allocation scheme (e.g., by utilizing a bitmap).

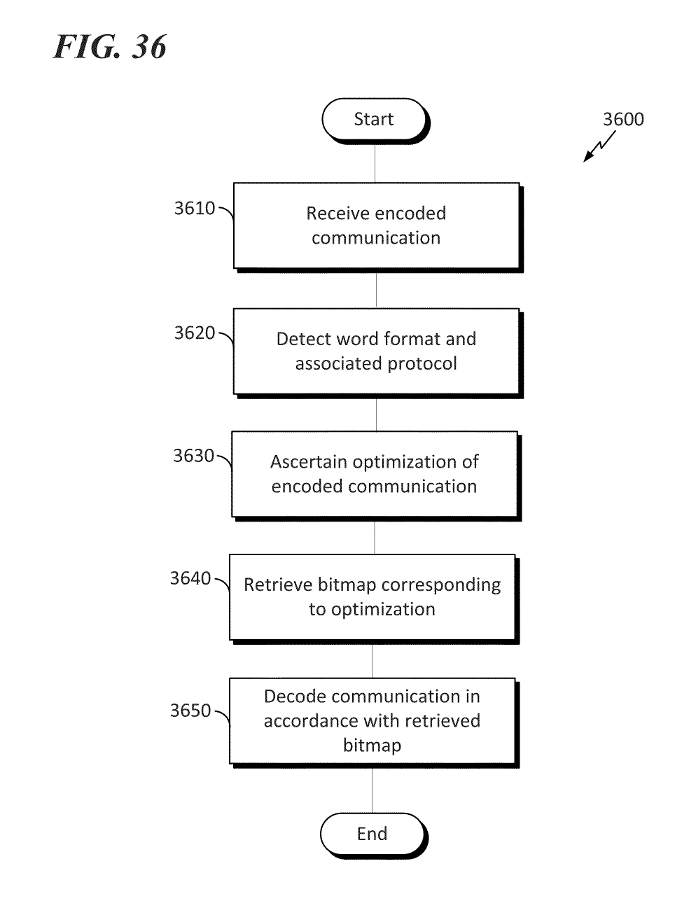

Referring next to FIG. 36, a flow chart illustrating an exemplary decoding methodology is provided in accordance with aspects disclosed herein. As illustrated, process 3600 includes a series of acts that may be performed within a computing device (e.g., master/slave device 3114) according to an aspect of the subject specification. For instance, process 3600 may be implemented by employing a processor to execute computer executable instructions stored on a computer readable storage medium to implement the series of acts. In another embodiment, a computer-readable storage medium comprising code for causing at least one computer to implement the acts of process 3600 is contemplated.

As illustrated, process 3600 begins with an encoded communication being received via a shared bus from another master/slave device at act 3610. Process 3600 then proceeds to act 3620 where the master/slave device detects a word format and associated protocol corresponding to the encoded communication. Since it is contemplated that the received communication may be encoded according to a particular optimization, process 3600 may then ascertain such optimization at act 3630, and subsequently retrieve a bitmap corresponding to the optimization at act 3640. For instance, where a word format corresponding to maximum symbol error detection is detected, a bitmap comprising twenty bits may be used, wherein the three least significant bits may be allocated for an error detection constant. Otherwise, if data throughput optimization is detected, the bit allocation scheme may comprise allocating only the least significant bit for the error detection constant and allocating the second and third least significant bits respectively for first and second most significant bits of a data portion of the word. Once the proper bit allocation scheme is identified, process 3600 then concludes at act 3650 where the encoded communication is decoded according to the bitmap retrieved at act 3640.

One or more of the components, steps, features, and/or functions illustrated in the Figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the Figures may be configured to perform one or more of the methods, features, or steps described in the Figures. The novel algorithms described herein may also be efficiently implemented in software and/or embedded in hardware.

In addition, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels and various other mediums capable of storing, containing, or carrying instruction(s) and/or data.

Furthermore, embodiments may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A device comprising:
a processor coupled to a control data bus,
wherein the processor is configured to facilitate an encoded communication of a word between a master device and a slave device via the control data bus, and
wherein the encoded communication is encoded according to a protocol that allocates a plurality of least significant bits of the encoded communication to facilitate maximizing an error detection constant, the protocol allocating the plurality of least significant bits to include at least one additional error detection bit or at least a first most significant bit of a data portion of the word.

2. The device of claim 1, wherein the control data bus is a two-line bus.

3. The device of claim 1, wherein the protocol is a Camera Control Interface extension (CCIe) protocol.

4. The device of claim 1, further comprising:
a bit allocation circuit configured to allocate bits according to a bit allocation scheme, wherein the bit allocation scheme allocates the plurality of least significant bits of the encoded communication;
an encoder circuit configured to facilitate an encoding of words, wherein the encoder circuit comprises:
a protocol subcircuit configured to determine a word format of the word associated with the protocol; and
an encoding subcircuit configured to encode words according to the word format and the bit allocation scheme to generate the encoded communication; and
a communication circuit configured to transmit the encoded communication via the control data bus.

5. The device of claim 4, wherein the encoding subcircuit is configured to encode words as encoded ternary numbers transcoded into symbols.

6. The device of claim 4, wherein the encoder circuit further comprises an optimization subcircuit configured to ascertain an optimization to implement via the word format and the bit allocation scheme.

7. The device of claim 6, wherein the optimization subcircuit is configured to facilitate switching between an encoding of words according to an error detection optimization having a first bit allocation scheme and an encoding of words according to a data optimization having a second bit allocation scheme.

8. The device of claim 6, wherein the encoding subcircuit is configured to encode words according to a data optimization in which the plurality of least significant bits comprises a fixed number of three bits, and wherein the bit allocation circuit is configured to facilitate the data optimization by allocating a least significant bit for error detection, a second least significant bit for the first most significant bit of the data portion of the word, and a third least significant bit for the second most significant bit of the data portion of the word.

9. The device of claim 6, wherein the encoding subcircuit is configured to encode words according to an error detection optimization in which the plurality of least significant bits comprises a fixed number of three bits, and wherein the bit allocation circuit is configured to facilitate the error detection optimization by allocating each of a least significant bit, a second least significant bit, and a third least significant bit for error detection.

10. The device of claim 1, further comprising:
a communication circuit configured to receive the encoded communication via the control data bus; and
a decoder circuit configured to facilitate a decoding of the encoded communication.

11. The device of claim 10, wherein the decoder circuit comprises:
a protocol subcircuit configured to detect a word format of the word associated with the protocol;
an optimization subcircuit configured to ascertain an optimization of the encoded communication and a bit allocation scheme corresponding to the optimization; and
a decoding subcircuit configured to decode the encoded communication according to the word format and the bit allocation scheme.

12. A method comprising:
coupling a master device to a slave device; and
facilitating an encoded communication of a word between the master device and the slave device via a control data bus, wherein the encoded communication is encoded according to a protocol that allocates a plurality of least significant bits of the encoded communication to facilitate maximizing an error detection constant, the protocol allocating the plurality of least significant bits to include at least one additional error detection bit or at least a first most significant bit of a data portion of the word.

13. The method of claim 12, wherein the control data bus is a two-line bus.

14. The method of claim 12, wherein the protocol is a Camera Control Interface extension (CCIe) protocol.

15. The method of claim 12, further comprising:
determining a word format of the word associated with the protocol;
allocating bits according to a bit allocation scheme, wherein the bit allocation scheme allocates the plurality of least significant bits of the encoded communication;
encoding the word according to the word format and the bit allocation scheme to generate the encoded communication; and
transmitting the encoded communication via the control data bus.

16. The method of claim 15, wherein the encoding comprises encoding words as encoded ternary numbers transcoded into symbols.

17. The method of claim 15, further comprising ascertaining an optimization to implement via the word format and the bit allocation scheme.

18. The method of claim 17, further comprising switching between an encoding of words according to an error detection optimization having a first bit allocation scheme and an encoding of words according to a data optimization having a second bit allocation scheme.

19. The method of claim 17, wherein the encoding comprises encoding words according to a data optimization in which the plurality of least significant bits comprises a fixed number of three bits, and wherein the allocating comprises facilitating the data optimization by allocating a least significant bit for error detection, a second least significant bit for the first most significant bit of the data portion of the word, and a third least significant bit for the second most significant bit of the data portion of the word.

20. The method of claim 17, wherein the encoding comprises encoding words according to an error detection optimization in which the plurality of least significant bits comprises a fixed number of three bits, and wherein the allocating comprises facilitating the error detection optimization by allocating each of a least significant bit, a second least significant bit, and a third least significant bit for error detection.

21. The method of claim 12, further comprising:
receiving the encoded communication via the control data bus; and
decoding the encoded communication.

22. The method of claim 21, further comprising:
detecting a word format of the word associated with the protocol;
ascertaining an optimization of the encoded communication and a bit allocation scheme corresponding to the optimization; and
decoding the encoded communication according to the word format and the bit allocation scheme.

23. A device, comprising:
means for coupling a master device to a slave device; and
means for facilitating an encoded communication of a word between the master device and the slave device via a control data bus, wherein the encoded communication is encoded according to a protocol that allocates a plurality of least significant bits of the encoded communication to facilitate maximizing an error detection constant, the protocol allocating the plurality of least significant bits to include at least one additional error detection bit or at least a first most significant bit of a data portion of the word.

24. The device of claim 23, further comprising:
means for determining a word format of the word associated with the protocol;
means for allocating bits according to a bit allocation scheme, wherein the bit allocation scheme allocates the plurality of least significant bits;
means for encoding the word according to the word format and the bit allocation scheme to generate the encoded communication; and
means for transmitting the encoded communication via the control data bus.

25. The device of claim 24, further comprising means for ascertaining an optimization to implement via the word format and the bit allocation scheme.

26. The device of claim 25, further comprising means for switching between an encoding of words according to an error detection optimization having a first bit allocation scheme and an encoding of words according to a data optimization having a second bit allocation scheme.

27. A non-transitory machine-readable storage medium having one or more instructions stored thereon, which when executed by at least one processor cause the at least one processor to:
couple a master device to a slave device; and
facilitate an encoded communication of a word between the master device and the slave device via a control data bus, wherein the encoded communication is encoded according to a protocol that allocates a plurality of least significant bits of the encoded communication to facilitate maximizing an error detection constant, the protocol allocating the plurality of least significant bits to include at least one additional error detection bit or at least a first most significant bit of a data portion of the word.

28. The non-transitory machine-readable storage medium of claim 27, wherein the one or more instructions further comprise instructions, which when executed by the at least one processor cause the at least one processor to:
determine a word format of the word associated with the protocol;
allocate bits according to a bit allocation scheme, wherein the bit allocation scheme allocates the plurality of least significant bits;
encode the word according to the word format and the bit allocation scheme to generate the encoded communication; and
transmit the encoded communication via the control data bus.

29. The non-transitory machine-readable storage medium of claim 28, wherein the one or more instructions further comprise instructions, which when executed by the at least one processor cause the at least one processor to:
encode words according to a data optimization in which the plurality of least significant bits comprises a fixed number of three bits; and
facilitate the data optimization by allocating a least significant bit for error detection, a second least significant bit for the first most significant bit of the data portion of the word, and a third least significant bit for the second most significant bit of the data portion of the word.

30. The non-transitory machine-readable storage medium of claim 28, wherein the one or more instructions further comprise instructions, which when executed by the at least one processor cause the at least one processor to:
encode words according to an error detection optimization in which the plurality of least significant bits comprises a fixed number of three bits; and
facilitate the error detection optimization by allocating each of a least significant bit, a second least significant bit, and a third least significant bit for error detection.
